(19) United States
(12) Patent Application Publication
(10) Pub. No.: US 2014/0093550 A1
(43) Pub. Date: Apr. 3, 2014

(54) Nanoparticle - Biocide Treatment of Biofilms

(71) Applicant: Clemson University, Clemson, SC (US)

(72) Inventors: Tamara L. McNealy, Clemson, SC (US); Olin Thompson Mefford, IV, Clemson, SC (US); Steven L. Saville, Williamston, SC (US)

(73) Assignee: Clemson University, Clemson, SC (US)

(21) Appl. No.: 14/045,026

(22) Filed: Oct. 3, 2013

Related U.S. Application Data
(60) Provisional application No. 61/709,184, filed on Oct. 3, 2012.
(60) Provisional application No. 61/825,130, filed on May 20, 2013.

(51) Int. Cl. A01N 25/26

(52) U.S. Cl. CPC A01N 25/26
USPC 424/419; 424/646; 424/649; 424/618

(57) ABSTRACT

A system of stabilized metallic nanoparticles is described that includes metallic nanoparticles coated with a hydrophilic polymer that has been reacted with a catechol-based ligand. Also described are stable, metallic nanoparticles that can be used alone or in conjunction with biocides, antibiotics, or other treatment systems in a method to disrupt a biofilm and facilitate its removal from a surface. The nanoparticles can be metal, such as platinum, silver, iron (II, III) oxide (Fe₃O₄), and gold. The nanoparticles can be sterically stabilized, such as with a polymer, or charge stabilized, such as with citrate, resulting in nanoparticles having modified surfaces. This surface modification is thought to enhance the stability of the nanoparticles and decrease their likelihood of aggregation, which, in turn, enhances their ability to disrupt and disperse existing biofilms.

### CROSS REFERENCE TO RELATED APPLICATIONS

This application claims filing benefit of previously filed U.S. Provisional Patent Application Ser. No. 61/709,184 having a filing date of Oct. 3, 2012 and U.S. Provisional Patent Application Ser. No. 61/825,130 having a filing date of May 20, 2013, each of which is incorporated herein by reference in its entirety.

### FEDERALLY SPONSORED RESEARCH AND DEVELOPMENT

This invention was made with government support under grant number NSF DMR 0907167 awarded by the National Science Foundation. The government may have certain rights in the invention.

### BACKGROUND OF THE INVENTION

Recently, there have been significant advances in the use of nanoparticles, such as magnetic nanoparticles, for various biomedical applications, including magnetic resonance imaging (MRI) contrast agents, magnetic particle imaging (MPI), drug delivery vehicles, and cancer therapy using magnetic hyperthermia. The most heavily used particle systems for these applications are iron oxide particles coated with dextran, which is popular because of its low cost, ease of creation, and biocompatibility.

There has also been significant research into particles coated by polymers using a “grafting-to” approach, where the terminal end of a polymer is bound to the surface. This method has significant advantages over dextran coatings because of increased stability inside biological media and the ability to tune the number of chains per unit area. Furthermore, the stabilizing molecular weight of the chains can be varied and therefore the resulting particle hydrodynamic diameter.

It has been reported that biological media may be extremely detrimental to the stability of the aforementioned magnetic nanoparticle systems, and it therefore important to understand particle stability inside of biological media. The stability of these polymer-particle systems in biological media is a crucial aspect for many potential applications, as the size and stability of these systems can determine uptake by the reticuloendothelial system (RES) and their final bio-distribution. The ability of nanoparticle systems to remain discrete in biological media furthermore dictates their usefulness in MPI, with it being recently proven that the mass sensitivity can be maximized by designing the magnetic nanoparticle core with a specific physical diameter. The sensitivity of this technique would decrease significantly if nanoparticles clustered in biological media. Finally, it has recently been shown that the magnetic nanoparticle core size plays a crucial role in their frequency response in magnetic hyperthermia, an effect that particle agglomeration would diminish dramatically.

Therefore, producing nanoparticles that are stable in biological media is critical to the success of the aforementioned applications. Thus, what is needed in the art is a method of coating nanoparticles, such as magnetite nanoparticles, that can stabilize the nanoparticles so that they can be used in various medical applications.

Meanwhile, in addition to the aforementioned biomedical applications such as MRI, MPI, drug delivery, and cancer treatment, nanoparticles can also be used in the context of treating biofilms. Biofilms are aggregates of microorganisms where cells adhere to each other on a surface. Biofilms are characterized by structural heterogeneity, genetic diversity, and complex community interactions. The cells are often embedded within a self-produced matrix of extracellular polymeric substance (EPS). The EPS is a polymeric conglomeration that generally contains extracellular DNA, proteins, and polysaccharides. Formation of a biofilm begins with the attachment of free-floating microorganisms to a surface. These first colonists adhere to the surface initially through weak, reversible van der Waals forces. If the colonists are not immediately separated from the surface, they can anchor themselves more permanently using cell adhesion molecules such as pili.

The first colonists facilitate the arrival of other cells by providing more diverse adhesion sites and beginning to build the matrix that holds the biofilm together. Only some species are able to attach to a surface on their own. Others are often able to anchor themselves to the matrix or directly to earlier colonists. Once colonization has begun, the biofilm grows through a combination of cell division and recruitment.

Biofilms are usually found on solid substrates submerged in or exposed to some aqueous solution. Many species of bacteria and archaea can live within a matrix of EPS, and the matrix protects the cells within it and facilitates communication among them through chemical and physical signals. Some biofilms have been found to contain water channels that help distribute nutrients and signaling molecules. This matrix is strong enough that in some cases, biofilms can become fossilized.

Bacteria living in a biofilm can have significantly different properties from free-floating bacteria, as the dense and protected environment of the film allows them to cooperate and interact in various ways. This results in increased resistance to detergents, biocides, and antibiotics, as the dense extracellular matrix and the outer layer of cells protect the interior of the community.

Biofilms can form on living or non-living surfaces and can exist in natural and industrial settings. For instance, biofilms can contaminate man-made aquatic systems such as cooling towers, medical lines, medical devices, spas, etc. In industrial environments, biofilms can develop on the interiors of pipes and lead to clogs and corrosion. In medicine, biofilms spreading along implanted tubes or wires can lead to infections in patients. Further, biofilms on floors and counters can make sanitation difficult in food preparation areas. Due to these detrimental effects, means for controlling or dispersing biofilms have been developed.

Currently, biofilms can be dispersed through the use of antibiotics and biocides. However, these treatments often require high concentrations of potentially toxic chemicals, raising environmental concerns, and these treatments or other preventative measures are often very expensive and can cost medical and industrial businesses billions of dollars.

Thus, while biofilms can be dispersed via conventional antibiotic and biocide treatments, room for improvement exists. Therefore, what is also needed in the art is a low toxicity, inexpensive composition that can disrupt and disperse established biofilms, such as via nanoparticles that have been stabilized via coating.

### SUMMARY OF THE INVENTION

In accordance with one embodiment of the present disclosure, a system of stabilized nanoparticles is contemplated. The system comprises metallic nanoparticles; a hydrophilic polymer; and a nitrocatechol-based ligand. The hydrophilic polymer is reacted with the nitrocatechol-based ligand to form a nitrocatechol-terminated hydrophilic polymer, and the metallic nanoparticles are coated with the nitrocatechol-terminated hydrophilic polymer.

In one embodiment, the metallic nanoparticles can be magnetic. For instance, the metallic nanoparticles comprise magnetite (Fe₃O₄).

In another embodiment, the metallic nanoparticles can comprise platinum, silver, gold, or a combination thereof.

In still another embodiment, the metallic nanoparticles can have an average diameter ranging from about 1 nanometer to about 50 nanometers.

In yet another embodiment, the hydrophilic polymer can comprise polyethylene glycol, polyethylene oxide, polyvinyl alcohol, polyacrylic acid, polymethacrylic acid, poly(maleic anhydride-alt-1-octadecane), polyethyleneimine, poly-N-vinyl-2-pyrollidone, cyclodextrin, or a combination thereof. For instance, the hydrophilic polymer comprises polyethylene glycol or polyethylene oxide.

In an additional embodiment, the nitrocatechol-based ligand can include a tri-nitrated 3,4 dihydroxy-L-phenylanaline (tri-nitroDOPA). For instance, the tri-nitroDOPA can have the following structure:

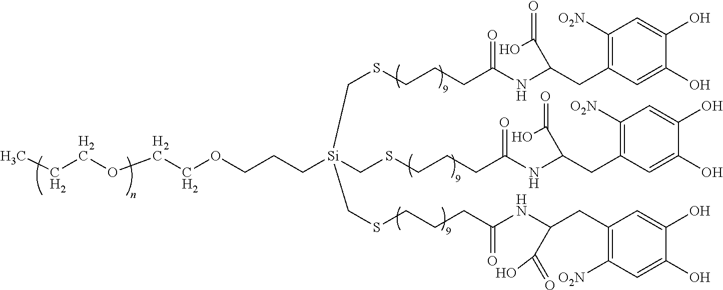

wherein n is an integer of 1 or greater.

In accordance with another embodiment of the present disclosure, a method for treating a surface to disrupt or disperse a biofilm present on the surface is described. The method comprises contacting a biofilm with a solution comprising from about 0.01 micrograms per liter to about 1000 micrograms per liter of stabilized metallic nanoparticles.

In one embodiment, the metallic nanoparticles can include platinum, silver, iron, gold, or a combination thereof.

In another embodiment, the stabilized metallic nanoparticles can be charge stabilized with negatively-charged citrate ions.

In yet another embodiment, the metallic nanoparticles can be sterically stabilized with a hydrophilic polymer. The hydrophilic polymer can comprise polyethylene glycol, polyethylene oxide, polyvinyl alcohol, polyacrylic acid, polymethacrylic acid, poly(maleic anhydride-alt-1-octadecane), polyethyleneimine, poly-N-vinyl-2-pyrollidone, cyclodextrin, or a combination thereof.

In one particular embodiment, the hydrophilic polymer can be reacted with a nitrocatechol-based ligand to form a nitrocatechol-terminated hydrophilic polymer. The nitrocatechol-based ligand can include a tri-nitrated 3,4 dihydroxy-L-phenylanaline (tri-nitroDOPA). For instance, the tri-nitroDOPA can have the following structure:

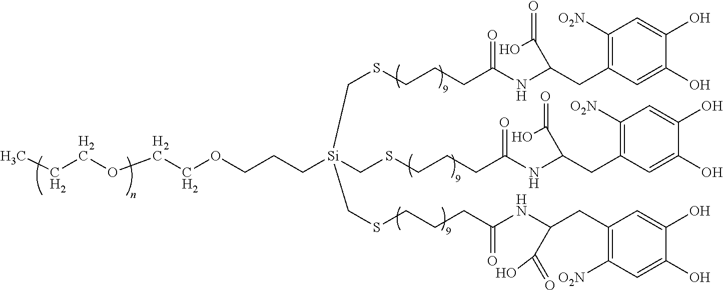

wherein n is an integer of 1 or greater.

In still another embodiment, the solution further comprises a biocide. The biocide can be present at a concentration ranging from about 0.01 milligrams per liter to about 1 gram per liter of the solution.

In accordance with another embodiment of the present disclosure, a biofilm treatment solution is described. The solution comprises from about 0.01 micrograms per liter to about 1000 micrograms per liter of stabilized metallic nanoparticles, wherein the nanoparticles have been stabilized with citrate ions or a hydrophilic polymer.

Other features and aspects of the present invention are set forth in greater detail below.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1(a) is a schematic depicting the three-step synthesis of PEO-DOPA;

FIG. 1(b) is a schematic depicting the three-step synthesis of PEO-nitroDOPA;

FIG. 2(a) is a representative image of 6.5 nanometer magnetite nanoparticles of the present disclosure;

FIG. 2(b) is a graph showing the core size of 6.5 nanometer magnetite nanoparticles of the present disclosure;

FIG. 3 is a graph showing the hydrodynamic sizes for PEO-DOPA coated nanoparticles as a function of PBS concentration;

FIG. 4 is a graph showing the hydrodynamic sizes for PEO-nitroDOPA coated nanoparticles as a function of PBS concentration;

FIG. 5 is a graph showing the hydrodynamic sizes for PEO-tri-nitroDOPA coated nanoparticles as a function of PBS concentration;

FIG. 6 shows the Z-average hydrodynamic size of PEO-DOPA coated magnetite nanoparticles as a function of time in deionized water, PBS, and FBS over a 24-hour period;

FIG. 7 shows the Z-average hydrodynamic size of PEO-nitroDOPA coated magnetite nanoparticles as a function of time in deionized water, PBS, and FBS over a 24-hour period;

FIG. 8 shows the Z-average hydrodynamic size of PEO-tri-nitroDOPA coated magnetite nanoparticles as a function of time in deionized water, PBS, and FBS over a 24-hour period;

FIG. 9(a) illustrates the effect of various concentrations of platinum-based nanoparticles on the bio-volume of a biofilm;

FIG. 9(b) illustrates the effect of various concentrations of platinum-based nanoparticles on the roughness coefficient of a biofilm;

FIG. 9(c) shows a control biofilm that is not treated with platinum-based nanoparticles;

FIG. 9(d) shows a biofilm after being treated with platinum-based nanoparticles at a concentration of 1 microgram/liter;

FIG. 9(e) shows a biofilm after being treated with platinum-based nanoparticles at a concentration of 100 micrograms/liter;

FIG. 10(a) illustrates the effect of various concentrations of silver-based nanoparticles on the bio-volume of a biofilm;

FIG. 10(b) illustrates the effect of various concentrations of silver-based nanoparticles on the roughness coefficient of a biofilm;

FIG. 10(c) shows a control biofilm that is not treated with silver-based nanoparticles;

FIG. 10(d) shows a biofilm after being treated with silver-based nanoparticles at a concentration of 1 microgram/liter;

FIG. 10(e) shows a biofilm after being treated with silver-based nanoparticles at a concentration of 100 micrograms/liter;

FIG. 11(a) illustrates the effect of various concentrations of Fe₃O₄-based nanoparticles on the bio-volume of a biofilm;

FIG. 11(b) illustrates the effect of various concentrations of Fe₃O₄-based nanoparticles on the roughness coefficient of a biofilm;

FIG. 11(c) shows a control biofilm that is not treated with Fe₃O₄-based nanoparticles;

FIG. 11(d) shows a biofilm after being treated with Fe₃O₄-based nanoparticles at a concentration of 1 microgram/liter;

FIG. 11(e) shows a biofilm after being treated with Fe₃O₄-based nanoparticles at a concentration of 100 micrograms/liter;

FIG. 12(a) illustrates the effect of various concentrations of gold-based nanoparticles on the bio-volume of a biofilm;

FIG. 12(b) illustrates the effect of various concentrations of gold-based nanoparticles on the roughness coefficient of a biofilm;

FIG. 12(c) shows a control biofilm that is not treated with gold-based nanoparticles;

FIG. 12(d) shows a biofilm after being treated with gold-based nanoparticles at a concentration of 1 microgram/liter;

FIG. 12(e) shows a biofilm after being treated with gold-based nanoparticles at a concentration of 100 micrograms/liter;

FIG. 13(a) illustrates the difference in biomass of a control biofilm and biofilms treated with 1 microgram/liter, 100 micrograms/liter, and 1000 micrograms/liter of gold-based nanoparticles;

FIG. 13(b) illustrates the difference in pigment production of a control biofilm and biofilms treated with 1 microgram/liter, 100 micrograms/liter, and 1000 micrograms/liter of gold-based nanoparticles;

FIG. 13(c) illustrates the difference in cell viability of a control biofilm and biofilms treated with 1 microgram/liter, 100 micrograms/liter, and 1000 micrograms/liter of gold-based nanoparticles;

FIG. 14 illustrates the reduction in bio-volume of a biofilm after 7 days of no treatment (control), treatment with a biocide, treatment with gold-based nanoparticles, treatment with a biocide and gold-based nanoparticles, treatment with erythromycin (EM), and treatment with ciprofloxacin (CM);

FIG. 15 illustrates the reduction in bio-volume of another biofilm after 7 days of no treatment (control), treatment with a biocide, treatment with gold-based nanoparticles, and treatment with a biocide and gold-based nanoparticles; and

FIG. 16 illustrates the fold increase in biomass volume of the biofilms of FIG. 14, 5 days after underdoing 7 days of no treatment (control), 7 days of treatment with a biocide, 7 days of treatment with gold-based nanoparticles, and 7 days of treatment with a biocide and gold-based nanoparticles.

### DETAILED DESORPTION OF PREFERRED EMBODIMENTS

Reference will now be made in detail to various embodiments of the disclosed subject matter, one or more examples of which are set forth below. Each embodiment is provided by way of explanation of the subject matter, not limitation of the subject matter. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment. Thus, it is intended that the present disclosure cover such modifications and variations as come within the scope of the appended claims and their equivalents.

Generally speaking, in one embodiment, the present disclosure is directed to a method of coating metal nanoparticles such that the nanoparticles can be stabilized and used in various biomedical applications, such as MRI, MPI, drug delivery, and cancer therapy, or any other suitable application, such as biofilm dispersion. The nanoparticles can include platinum, silver, iron (e.g., magnetite (Fe₃O₄)), gold, or any other suitable metal or magnetic material as a base or core material. For instance, the nanoparticles can include platinum, silver, iron (e.g., magnetite (Fe₃O₄)), gold, or any other suitable metal as a base or core material. The average diameter of the nanoparticles can be about 50 nanometers or less, such as from about 1 nanometer to about 50 nanometers in some embodiments, from about 2 nanometers to about 25 nanometers in other embodiments, and from about 3 nanometers to about 20 nanometers in still other embodiments.

In one particular embodiment, a coating can be applied to the magnetic nanoparticles to render the particles stable in biological media. While the biological stability of such nanoparticle systems is governed by many different aspects, one important aspect is the type of surface coating utilized. For magnetic (e.g., magnetite) nanoparticle systems using an anchored polymer brush, the binding strength of the anchor group is important as any displacement of these anchor groups by biological media results in the lowering of the polymer brush density, decreasing particle stability, and increasing the likelihood of particle clustering. Common anchor groups that can be employed are carboxylic acid, silanes, and phosphonates. More recently, catechols and nitrocatechols have garnered increasing interest as an alternative to more traditional binding groups, due to their robust anchoring to iron oxide nanoparticles. Amstad, et al. (Nano Lett., 2009, 9, 4042-4048) have demonstrated that nitrated 3,4 dihydroxy-L-phenylanaline (nitroDOPA) anchor groups provide significant advantages over other anchor groups in that they provide robust adhesion even in the presence of phosphate buffered silane (PBS). Other research groups have adopted the strategy of creating multi-anchor ligands with the purpose resisting displacement by having multiple attachment points. For example, Goff et al. (Chem. Mater., 2009, 21, 4784-4795) have been successful in creating a tri-phosphonate poly(ethylene oxide) (PEO) ligand that has shown high binding strength to magnetite, with very little displacement in PBS. However, there is still a need for improved adhesion between the polymer and nanoparticle.

The inventors of the present disclosure have discovered that magnetic nanoparticles can be treated with a tri-nitroDOPA terminated hydrophilic polymer to stabilize the nanoparticles when introduced to synthetic biological conditions, such as phosphate buffered saline (PBS) and fetal bovine serum (FBS). PBS is a common isotonic buffer solution employed in cell culture media to maintain the osmolarity of the cells, while (FBS) is a common growth supplement used in cell culture media and contains a protein rich environment. The hydrophilic polymer can include polyethylene glycol (PEG), polyethylene oxide (PEO), polyvinyl alcohol (PVA), polyacrylic acid (PAA), polymethacrylic acid (PMAA), poly(maleic anhydride-alt-1-octadecane), polyethyleneimine (PEI), poly-N-vinyl-2-pyrollidone (PNVP), or cyclodextrin. The examples below explain how the nanoparticles were coated with the tri-nitroDOPA and also show the effectiveness of the tri-nitroDOPA at stabilizing magnetic nanoparticles.

One measure of showing the improved stability of nanoparticles stabilized with tri-nitrated 3,4 dihydroxy-L-phenylanaline (tri-nitroDOPA) is to compare the surface coverage of nanoparticles coated with a polymer utilizing a tri-nitroDOPA anchor with nanoparticles coated with polymers utilizing other anchoring materials before and after exposure to a biological media. For instance, after dialysis against 1×PBS for 48 hours at a pH of about 7.4, both PEO-DOPA and PEO-nitroDOPA coated nanoparticles show significant amounts of polymer removal, as evidenced by a reduction in the surface coverage (in chains per nanometer squared) of the polymer coating on the nanoparticles. Specifically, the PEO-DOPA coated nanoparticle sample shows a reduction in the surface coverage greater than meanwhile 30%. Further, although the PEO-nitroDOPA coated nanoparticles show a reduction in the surface coverage that is not as great, a reduction of about 25% was still observed. This is in stark contrast to PEO-tri-nitroDOPA coated nanoparticle samples, which can show a reduction in surface coverage ranging from about 0.5% to about 20%, such as from about 1% to about 15%, such as from about 2% to about 10%. For instance, in one embodiment, the surface coverage reduction is only about 8% when the nanoparticles are coated with PEO-tri-nitroDOPA. This retention of surface coating density is extremely important in biological media, as significant reduction of the polymer coating can significantly lower the steric repulsion of these particles, which, in turn, results in particle agglomeration and eventual flocculation. Such agglomeration hinders the ability of magnetic nanoparticles to be utilized in such applications as MRI and MPI, where the ability of the nanoparticles to remain discrete is important.

In another embodiment, the present disclosure is directed to treated or coated nanoparticles and the use of such nanoparticles, either alone or in combination with a biocide, for the disruption and dispersion of biofilms, such as to remove the biofilm from a surface. The present disclosure describes a nanoparticle treatment that results in nanoparticles that are stable and discrete, resulting in high levels of destabilization and disruption of biofilms. Any metal can be used as the base material of the nanoparticle. For instance, the nanoparticles can include platinum, silver, iron (e.g., magnetite (Fe₃O₄)), gold, or any other suitable metal as a base or core material. The average diameter of the nanoparticles can be about 50 nanometers or less, such as from about 1 nanometer to about 50 nanometers in some embodiments, from about 2 nanometers to about 25 nanometers in other embodiments, and from about 3 nanometers to about 20 nanometers in still other embodiments.

When the nanoparticles are used in a dispersion medium, such as a solution used in treating biofilms, the nanoparticles can have a tendency to collide with each other due to Brownian motion. The stability of the nanoparticles thus can depend at least in part on the interaction between the nanoparticles when they collide. The interaction can be attractive or repulsive, with a repulsive interaction providing stability (i.e., lack of aggregation) to the nanoparticles so that they remain well dispersed, and an attractive interaction leading to aggregation and loss of activity during use. Van der Waals forces are the primary sources of attractive interaction between nanoparticles, so in order to stabilize a dispersion of nanoparticles, there should be a sufficiently strong repulsive force to counteract the van der Waals attraction. To counteract the attractive forces, the nanoparticles can be stabilized via a surface treatment or coating so that the nanoparticles remain discrete and do not aggregate when utilized in a biofilm treatment solution.

The nanoparticles can be charge stabilized or sterically stabilized in order to prevent aggregation in solution. According to a charge stabilization process, the nanoparticles can be provided with Coloumbic repulsion in a polar liquid by the introduction of ionic groups that can anchor to the surface of a nanoparticle through various mechanisms (e.g., absorption, adsorption, covalent or non-covalent bonding, etc.) to form a charged layer. The nanoparticles, now having the same surface charge as one another, will thus be repelled from one another in a solution, thus preventing aggregation of the particle. Meanwhile, to maintain electroneutrality, an equal number of counterions with an opposite charge to the groups anchored on the nanoparticle surface can surround the nanoparticles and give rise to overall charge-neutral double layers on the nanoparticles. In charge stabilization, it is understood that the mutual repulsion of these double layers surrounding the nanoparticles can provide stability to the nanoparticles. The thickness of the double layer and the ability of the double layer to counterbalance the van der Waals forces generally depends on the ionic strength of the medium in which the nanoparticles are dispersed. It should be noted that as the ionic strength of the medium increases, charge-stabilized nanoparticles show a tendency to aggregate and thus destabilize. Further, charge stabilization is generally more effective in aqueous dispersion media as opposed to nonaqueous dispersion media, which is thought to be due to the low relative dielectric constant (e.g., less than 10) of most nonaqueous media.

In one embodiment, for example, the nanoparticles can be charge stabilized through the surface absorption of ions, such as negatively-charged citrate ions, although any ion with a charge opposite to that of the nanoparticles can be used in an absorption-based process. The repulsion between the negatively-charged citrate ions stabilizes the suspension of nanoparticles by preventing the nanoparticles from aggregating. Specifically, citrate ions can adhere to a metal nanoparticle core, forming a shell of negatively charged ions around the particle. The negative net charge on the nanoparticles can stabilize the particles due to electrostatic interactions across an aqueous media.

In another embodiment, the nanoparticles can be sterically stabilized with a polymer coating. Steric stabilization of nanoparticles can be achieved by attaching macromolecules to the surfaces of the particles via, for example, grafting or chemisorption. Nanoparticles can be straightforwardly stabilized by attachment of large, bulky molecules, e.g. polymers, onto the surface. As the modified particles approach each other, the surface-bound molecules must reorganize or compress due to the size exclusion effect. Upon reorganization, the conformational entropy of the individual molecules decreases, resulting in a net repulsive force between the particles.

In general, any polymer suitable for use in the dispersion medium can be utilized to sterically stabilize the nanoparticles, such as hydrophilic polymers. For example, hydrophilic polymer coatings can include polyethylene glycol (PEG), polyethylene oxide (PEO), polyvinyl alcohol (PVA), polyacrylic acid (PAA), polymethacrylic acid (PMAA), poly(maleic anhydride-alt-1-octadecane), polyethyleneimine (PEI), poly-N-vinyl-2-pyrollidone (PNVP), or cyclodextrin polymer.

Further, in order to bind the polymer to the nanoparticle, anchor groups can be utilized. The anchor groups can have a high binding strength with both the nanoparticle surface and the macromolecule so as to resist any displacement of the polymer from the nanoparticle surface, for instance by components of the media in which the materials will be used. Displacement of polymers will lower polymer brush density, and can thus decrease particle stability and increase particle clustering or aggregation. Representative anchor groups can include, without limitation, acids, silanes, phosphates, catechols, and nitrocatechols. Forms of nitrocatechol anchor groups include DOPA, nitroDOPA and tri-nitroDOPA. For example, nanoparticles coated with a tri-nitroDOPA-anchored polymer coating have a robust anchor that prevents disruption of a polymer coating held in biological media for several days.

Formation of a tri-nitroDOPA-Capped Polymer

A method for forming a PEO polymer with a tri-nitroDOPA anchor group attached thereto is discussed below, although other types of polymers can also be capped with tri-nitroDOPA following similar methods. The tri-nitroDOPA-polymer can be coated onto various types of metal nanoparticles to stabilize the nanoparticles. To form the tri-nitroDPA PEO polymer, first an alkoxide initiator solution can be formed, which can then be used in the synthesis of a trivinyl PEO polymer, after which a tricarboxylic acid PEO can be formed. This can be followed by synthesis of Tri-N-Hydroxysuccinimide PEO (tri-NHS terminated PEO), after which tri-nitroDOPA PEO can be formed by reacting the tri-NHS synthesized polymer with nitroDOPA. Each of these steps is discussed below. Of course, it is to be understood that other polymers using the same or different anchor groups can also be formed and used to coat various types of metal nanoparticles in order to provide particle stability and prevent particle aggregation and to form metal nanoparticles that can disrupt a biofilm.

### Synthesis of Trivinyl(3-hydroxypropyl)silane Alkoxide Initiator

For creation of a tri-nitroDOPA capped polymer, a trivinyl polymer such as a trivinyl PEO polymer can first be synthesized. Briefly, 3-chloropropyltrichlorosilane can be combined with vinylmagnesium chloride at about 60° C. in anhydrous THF under nitrogen at reflux for about 24 hours. After reaction, the solution can be concentrated using a rotary evaporator, followed by dissolving the product in dichloromethane and filtration to remove salt by-products. The product is then purified by vacuum distillation at about 100° C. and about 0.8 Torr to yield trivinyl(3-chloropropyl)silane.

In the next reaction step, trivinyl(3-chloropropyl)silane can be converted to trivinyl(3-iodopropyl)silane by reaction of the product from the previous reaction with a 2-fold excess of NaI in acetone for about 48 hours at about 60° C. Following the reaction, the acetone can be removed by rotary evaporation, and the product then dissolved in chloroform. The salt byproducts and impurities can then be removed by vacuum filtration. Next, the trivinyl(3-iodopropyl)silane product can then be purified by vacuum distillation at about 70° C. and about 0.8 Torr.

In the next initiator synthesis step, trivinyl(3-iodopropyl)silane can be converted to trivinyl(3-hydroxypropyl)silane by reacting the product from the previous reaction with hexamethylphosphoramide (HMPA), sodium bicarbonate, and deionized water at about 100° C. for about 24 h. The product can then be extracted twice from the aqueous mixture with chloroform in a separatory funnel. The chloroform can then be evaporated by rotary evaporation, and the trivinyl(3-hydroxypropyl)silane product purified by vacuum distillation at about 90° C. and about 0.8 Torr. Trivinyl(3-hydroxypropyl)silane can be confirmed by ¹H NMR. To complete the initiator synthesis, the trivinyl(3-hydroxypropyl)silane can be reacted with potassium naphthalide in THF under a heavy nitrogen purge to form the alkoxide initiator.

### Synthesis of Trivinyl-Poly(ethylene oxide)

Next, a description of the synthesis of a trivinylsilylpropoxy-terminated poly(ethylene oxide) is discussed herein. Initially, a 300 mL Parr pressure reactor can be cooled to about −50° C. utilizing a liquid nitrogen/acetone bath. Ethylene oxide can then be distilled into the Parr reactor using a pressure and temperature gradient. The alkoxide trivinyl(3-hydroxypropyl)silane initiator solution as formed by the process described above can then be added to the Parr reactor via syringe along with an additional aliquot of THF. The liquid nitrogen/acetone bath can then be removed from the reactor and the solution allowed to warm to room temperature. The solution can then be stirred for about 24 hours. After reaction, the polymerization can be terminated by the addition of acetic acid in THF under nitrogen. The solution can then be removed from the reactor and precipitated into diethyl ether. The product can then be re-dissolved into dichloromethane and washed twice with water. The solid product of trivinyl-poly(ethylene oxide) can then be obtained by evaporating the solvent and confirmed by ¹H NMR.

### Synthesis of Tricarboxylic Acid Poly(Ethylene Oxide)

To create a tri-carboxylic acid terminated PEO, trivinyl-PEO created from the previous reaction can be reacted with mercaptoundecanoic acid and 2,2′-azobisisobutyronitrile (AIBN) in toluene at about 80° C. for about 2 hours. The solvent can be removed using a rotary evaporator and re-dispersed into dichloromethane. The solution can then be precipitated into ethyl ether and the final product of tri-carboxylic acid terminated PEO can be filtered and vacuumed dried overnight to remove any residual solvent.

### Synthesis of Tri-N-Hydroxysuccinimide Poly(Ethylene Oxide)

In order to activate the synthesized tri-carboxylic acid terminated polymer for reaction with an amine, the carboxylic acid functionalities can then be conjugated with N-hydroxysuccinimide (NHS). Generally, in a typical reaction, a tri-carboxylic acid terminated PEO can be dissolved in chloroform. Dicyclohexylcarbodiimide (DCC) can then be added to the solution, which can be stirred for about 1 hour. NHS can then be added to the solution, and the mixture allowed to react for about 4 hours. The solution can then be filtered to remove impurities and precipitated with ethyl ether and vacuum dried overnight, resulting in the final product of tri-NHS terminated PEO.

Synthesis of Tri-nitroDOPA Poly(Ethylene Oxide)

In the final reaction step, the tri-NHS synthesized polymer can be reacted with nitroDOPA to form a tri-nitroDOPA terminated polymer. First, L-DOPA can be converted to nitroDOPA, for example, by dissolving L-DOPA in deionized water along with sodium nitrite. The solution can then be placed in a salt/ice bath and allowed to cool down to about 4° C. A solution of sulfuric acid in deionized water can then be slowly dripped into the system at a rate of about 2 mL/min. The formation of nitroDOPA can be indicated by precipitation of a yellow/brown solid. The reaction mixture can then be filtered to remove the nitroDOPA, and the resultant precipitant can be washed with methanol to remove impurities. Nitration on L-DOPA into nitroDOPA can be confirmed by ¹H NMR.

Next, to form a tri-nitroDOPA terminated polymer, the tri-NHS PEO formed as described above can be dissolved into dimethyl formamide (DMF) under a heavy nitrogen purge. To this solution, nitroDOPA can be added via syringe. The solution can react for about 8 hours, and can be followed by precipitation using ethyl ether, resulting in a white polymer with very light hint of yellow that can then be dissolved in chloroform and filtered to remove impurities. The chloroform solution was then precipitated with hexane and vacuum dried overnight resulting in the final product tri-nitroDOPA terminated PEO.

The resulting tri-nitroDOPA-terminated PEO, which can be used as a stabilizing coating on metal nanoparticles, has the structure shown in formula (I) below, where n is an integer of one or greater:

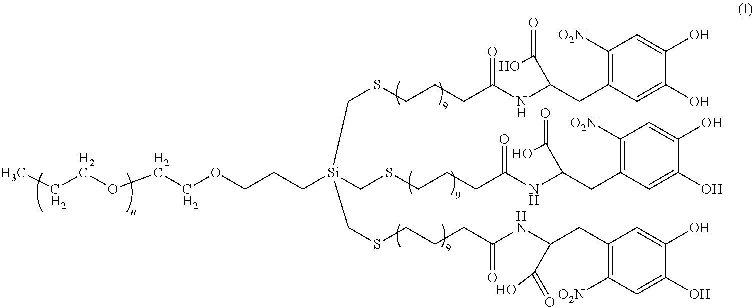

Whether coated with a polymer such as a tri-nitroDOPA-capped polymer or charge-stabilizing ions as discussed above, the metallic nanoparticles of the present disclosure can disrupt and disperse biofilms over a range of concentrations of the nanoparticles per liter of media. For example, the concentration of the nanoparticles can range from about 0.01 micrograms/liter to about 1000 micrograms/liter in some embodiments, from about 0.01 to about 500 micrograms/liter in some embodiments, and from about 0.1 micrograms/liter to about 250 micrograms/liter in still other embodiments. However, although a wide concentration range can successfully disperse biofilms, the ability of the nanoparticles is effective at lower concentrations, which can provide significant cost savings. For instance, the concentration of the nanoparticles can range from about 0.01 micrograms/liter to about 100 micrograms/liter in some embodiments, from about 0.01 to about 50 micrograms/liter in some embodiments, and from about 0.1 micrograms/liter to about 25 micrograms/liter in still other embodiments and effectively be able to disperse and disrupt existing biofilms.

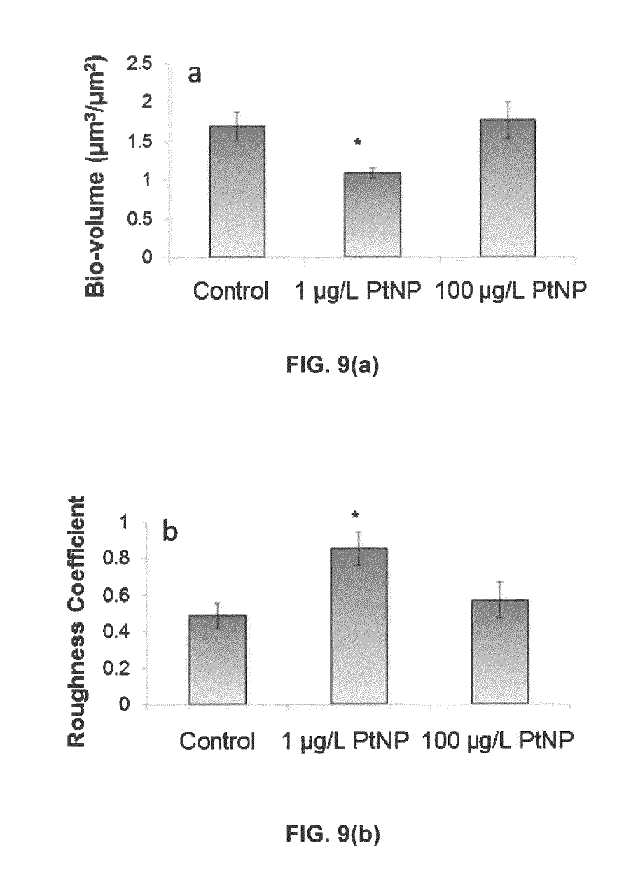

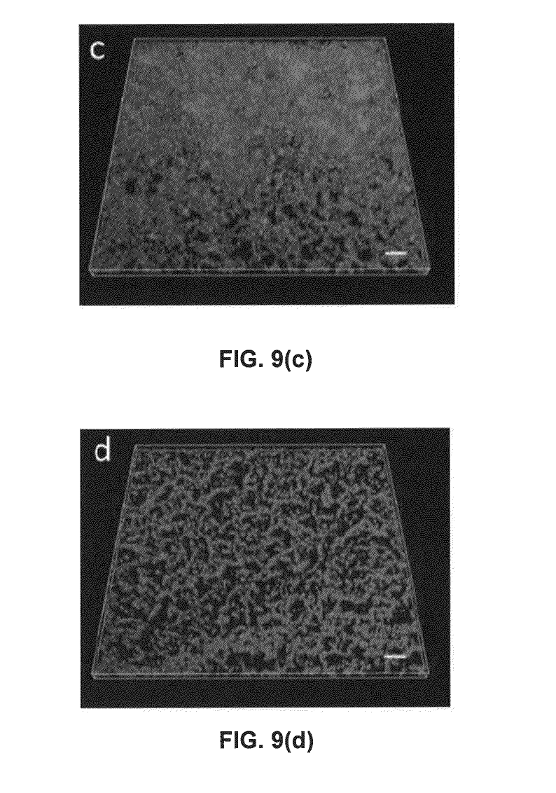

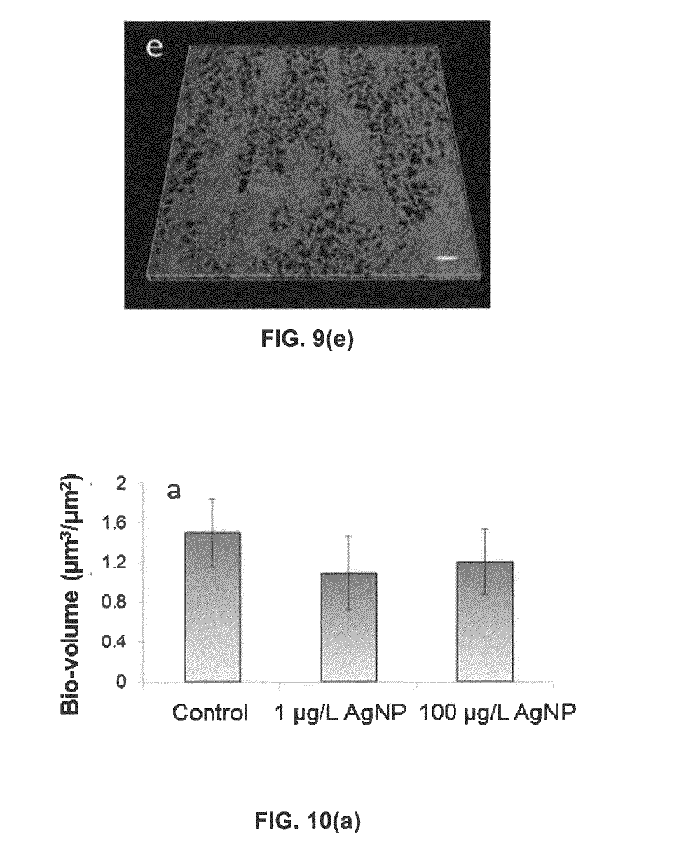

As shown in FIGS. 9-16, when applied alone, the stabilized (i.e., coated) metallic nanoparticles can reduce the bio-volume and increase the roughness coefficient of a biofilm to which the nanoparticles are applied. Thus, the stabilized metallic nanoparticles can be used to reduce the biomass of biofilms. For example, the stabilized metallic nanoparticles can reduce the biomass of biofilms in medical devices and lines, as well as cooling towers or aquariums, ponds, or other aquatic systems.

In one embodiment, the stabilized nanoparticles can be used in conjunction with an oxidizing or non-oxidizing biocide to further improve the disruption and/or destruction of a biofilm. It should further be understood that the stabilized metallic nanoparticles can be utilized in conjunction with a combination of biocides. Oxidizing biocides can include, without limitation, halogen-based biocides. For example, chlorine and bromine-based biocides, such as sodium hypochlorite, chlorine dioxide, chloroisocyanurates, bromine, 1-bromo-3-chloro-5,5-dimethylhydantoin, bromine chloride and bromine-chlorine mixtures, etc. can be used.

Non-oxidizing biocides can include, without limitation, quaternary ammonium compounds, 2-bromo-4-hydroxyacetophenone, 2-bromo-2-nitropropane-1,3-dial, sodium dimethyldithiocarbamate (DIBAM), disodium ethylene bisdithiocarbamate (NIBAM), potassium n-hydroxymethyl-n-methyldithiocarbamate, 2,2 dihydroxy-5,5-dichlorodiphenyl monosulfide, 2-2-dibromo-3-nitrilopropionamide, 2-(decylthio)ethanamine, guanides such as dodecylguanidine hydrochloride, dodecylguanidine acetate, tetraedecylgaunidine, and polyhexamethylene biguanide hydrochloride, gluteraldehyde, isothiazolines, methylene bis(thiocyanate) (MBT), triazine, sulfone, bis(tributyltin) oxide, tetrachloro-2,4,6-cyano-3-benzonitrile, 2(thiocyanomethylthio)benzothiazole, tetrahydro-3,5-dimethyl-2H-1,3,5-thiadiazine-2-thione, tetrakish(hydroxymethyl)phosphonium sulfate, tributyltetradecylphosphonium chloride, etc.

Regardless of the biocide used, when a biocide is used in conjunction with a stabilized metallic nanoparticle to treat a biofilm, the biofilm can be treated by any suitable method. For example, the biocide or biocides can be applied to the biofilm separately from the nanoparticles or with the nanoparticles as a single solution. In those embodiment in which the biocide is applied to the biofilm separately from the nanoparticles, the biocide can be applied first, followed by the nanoparticles, or the nanoparticles can be applied first, followed by the biocide. Regardless of the manner or order in which the biocide is applied, the biocide can generally be applied at a concentration less than about 1.0 gram/liter (g/L). For example, the concentration at which the biocide can be applied can range about 0.01 milligrams/L (mg/L) to about 1.0 g/L in some embodiments, from about 0.05 mg/L to about 0.75 mg/L in other embodiments, and from about 0.1 mg/L to about 0.5 mg/L in still other embodiments.

As shown in FIGS. 14-16, applying a biocide in conjunction with stabilized metallic nanoparticles can reduce the biomass significantly after 7 days of treatment. The combination of biocides with stabilized metallic nanoparticles can be used to reduce and prevent biofilm formation in medical devices, medical lines such as dental lines, plumbing systems, and cooling towers. Additionally, because many cooling towers are recirculating, the nanoparticles can be reused, which provides cost savings. Other cooling towers empty into the natural environment, and because the nanoparticles can be used in conjunction with biocides and provide improved biofilm destruction/dispersion, a lower concentration of biocides can be used, which can reduce the risk of harm to the environment. Further, as shown in FIG. 16, the combination of a biocide with stabilized metallic nanoparticles can prevent regrowth of a biofilm at least for up to about 5 days post-treatment when the biofilm is treated for 7 days and then treatment is stopped. Without intending to the limited by theory, it is believed that the nanoparticle interaction with the matrix components of the biofilm leads to biofilm destabilization. Further, uptake of the nanoparticles by the bacteria is believed to alter virulence gene expression and the ability to maintain coherent biofilms. When used in conjunction with a biocide to form a biofilm treatment composition, the stabilized metallic nanoparticles and the biocide can act synergistically to break up the biofilm and kill the microbes, such as bacteria, contained therein.

Compositions and methods as disclosed herein may be better understood with reference to the following test procedures and examples.

### Example 1

In Example 1, several polymers with different anchor for sterically stabilizing magnetite nanoparticles were formed and tested for their ability to stabilize various nanoparticles in order to compare a tri-nitroDOPA terminated PEO polymer coating with other polymer coatings.

To determine the stability of particles modified with a newly synthesized tri-nitroDOPA ligand in these synthetic biological medias, the displacement of the tri-nitroDOPA polymer coating after dialysis against PBS for 48 hours was measured. Furthermore, the hydrodynamic size of this magnetite suspension was measured as a function of PBS concentration. Finally, the time dependent stability of the suspension in the presence of PBS and FBS was tested by measuring the hydrodynamic size of the suspension as a function of time. These results were then compared to the stability of magnetite nanoparticles stabilized with PEO ligands with a monofunctional 3,4 dihydroxy-L-phenylanaline (L-DOPA) and nitroDOPA anchor group in order to determine the effect a multi-group anchor (tri-nitroDOPA).

### Materials and Test Procedures for Example 1

### Materials

3-Chloropropyltrichlorosilane was purchased from Gelest and was fractionally distilled under reduced pressure prior to use. Tetrahydrofuran (THF) was purchased from Fisher Scientific and was dried over calcium hydride before use. Sodium iodide was purchased from Aldrich and dried in a vacuum oven overnight at 11° C. Naphthalene was purchased from Aldrich and was purified by sublimation. Linear monofunctional hydroxyl terminated poly(ethylene oxide)monomethyl ether (PEO-OH) of molecular weight 5000 g mol⁻¹ was purchased from Sigma Aldrich and was dried at 100° C. in a vacuum oven overnight prior to use to remove water. Oleylamine was purchased from Sigma Aldrich and was fractionally distilled before use. Finally, iron(III) acetylacetonate was purchased from Fluka and used without further purification. A 1.6 M solution of vinylmagnesium chloride in THF, hexamethylphosphoramide (HMPA), benzyl ether, triethyl amine (TEA), dimethyl foramide (DMF) toluene, ethyl ether, dimethyl aminopyridine (DMAP), dicyclohexycarbodiimide (DCC), N-hydroxysuccinimide (NHS), hexane, ethanol, succinic anhydride, sodium nitrite, sulfuric acid (95%), L-DOPA sodium bicarbonate, potassium metal, ethylene oxide, diethyl ether, toluene, mercaptoundecanoic acid, 2,2-azobisisobutyronitrile (AIBN), dichloromethane, acetone, chloroform, phosphate buffered silane (PBS, pH 7.4), and acetic acid were all purchased from Sigma Aldrich and were used as received.

### Synthesis of Iron Oxide Nanoparticles

Particles were prepared via a modified method first presented by Sun and Zeng (J. Am. Chem. Soc., 2002, 124, 8204-8205). Briefly, magnetite particles were produced by adding iron(III) acetylacetonate (Fe(acac)₃, 0.35 g, 1 mmol) and oleylamine (OAm, 2.5 mL, 17.09 mmol) in 17.5 mL of benzyl ether to a round bottom flask under a nitrogen blanket. The solution was then heated at 3° C. per minute to 300° C. and held isothermally for 1 hour. The particles were purified by repeated washing with ethanol and centrifugation.

### Synthesis of Polymer Ligands

To investigate the role of the anchor group on nanoparticle stability in synthetic biological media, three PEO polymers with very similar molecular weights containing a L-DOPA, nitro-DOPA and tri-nitroDOPA anchor were synthesized. The synthesis for each ligand is presented below.

### Synthesis of PEO5000 DOPA

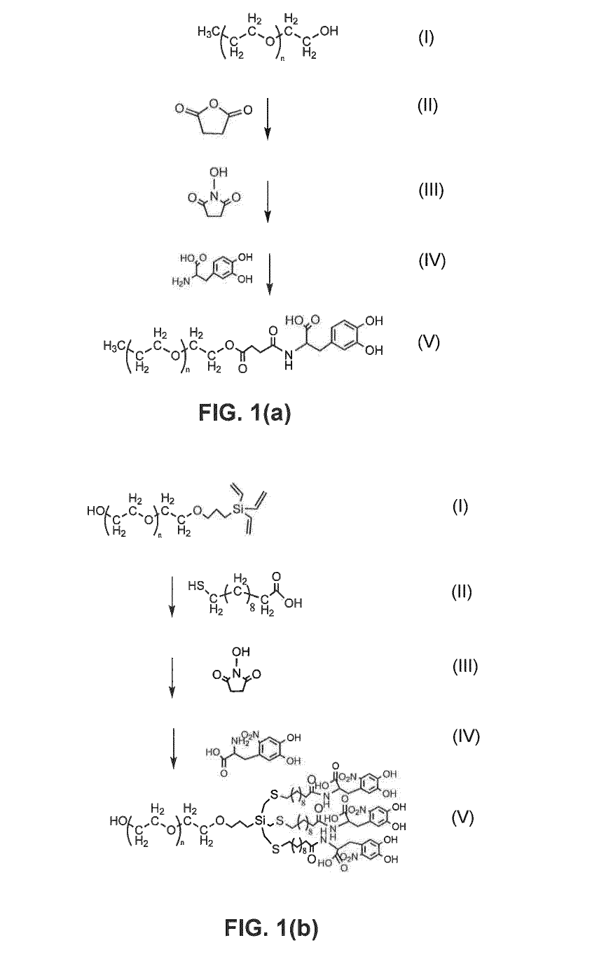

Turning to FIG. 1(a) and as shown in structures (I) through (V), hydroxyl terminated monofunctional PEO (5000 g mol⁻¹ MW, 10 g, 2 mmol) was reacted with succinic anhydride (0.25 g, 2.5 mmol) and DMAP (0.24 g, 2 mmol) and TEA (0.202 g, 2 mmol) in anhydrous THF (20 mL) at room temperature for 8 hours. The polymer was then precipitated into ethyl ether and centrifuged for collection, followed by extraction using dichloromethane, yielding a carboxylic acid terminated monofunctional PEO (9.12 g, 89.4% yield). The resultant product of a carboxylic acid terminated PEO (9.12 g, 1.79 mmol) was then reacted with DCC (0.46 g, 2.23 mmol) and NHS (0.21 g, 1.79 mmol) in THF (20 mL) at room temperature for 4 hours. The product was purified via vacuum filtration and precipitation into isopropyl ether, resulting in a NHS terminated PEO (7.98 g, 85.6% yield). Finally, PEO-NHS (7.98 g, 1.53 mmol) was reacted with L-DOPA (0.392 g, 1.98 mmol), in an anhydrous solution of DMF (10 mL) to create a L-DOPA terminated PEO, as shown in FIG. 1(a). The polymer was purified by precipitation into ethyl ether, re-dispersion into dichloromethane, and vacuum filtered (5.72 g, 70.6% yield). Polymer modification was verified by nuclear magnetic resonance (NMR) spectroscopy by peaks at 6.6, 6.75, 6.85 ppm (CH, ring, DOPA), 2.7, 2.8 ppm (doublet, ring-CH₂—CH, DOPA), 2.1 ppm (O═CH₂—CH₂—C═O, succinic anhydride addition), and 3.65 ppm (O—CH₂—CH₂—O, PEO).

### Synthesis of PEO5000 nitroDOPA

To provide a more robust anchor to magnetite, L-DOPA was converted to nitroDOPA using a similar method as described by Yang, et al, (Biomaterials, 2011, 32, 4151-4160). Nitration on L-DOPA into nitroDOPA was confirmed by ¹H NMR by peaks at 6.1 ppm (CH, ring, nitroDOPA), 6.8 ppm (CH, ring, nitroDOPA), 1.8 ppm and 2.4 ppm (ring-CH₂—CH₂—C).

To modify PEO with nitroDOPA, the reaction performed was similar to the previously described method of preparation of PEO-DOPA, with the exception that nitroDOPA was substituted for L-DOPA in the final modification step. The structures formed during the process are shown as structures (I) through (V) in FIG. 1(b). Polymer modification was verified by NMR by peaks appearing at 6.1 and 6.75 ppm (CH, ring, nitroDOPA), 2.7 ppm (triplets, CH₂—CH₂, nitroDOPA), 2.1 ppm (O═C—CH₂—CH²—C═O, succinic anhydride addition), and 3.65 ppm (O—CH₂—CH₂—O, PEO).

### Synthesis of trivinyl(3-hydroxypropyl)silane

For creation of a tri-nitroDOPA polymer, a trivinyl PEO polymer (FIG. 1(b)) must first be synthesized, which was previously reported by Vadala, et al. (Biomacromolecules, 2008, 9, 1035-1043). Briefly, 3-chloropropyltrichlorosilane (0.07 mol, 0.024 equiv. of chlorosilane, 3.7 mL, 5 g) was reacted with vinylmagnesium chloride (0.08 mol, 50 mL of a 1.6 M vinylmagnesium chloride solution in THF) at 60° C. in 10 mL of anhydrous THF under nitrogen at reflux for 24 hours. After reaction, the solution was concentrated using a rotary evaporator, followed by dissolving the product in dichloromethane and filtration to remove salt by-products. The product was then purified by vacuum distillation at 100° C. and 0.8 Torr to yield the product, trivinyl(3-chloropropyl)silane.

In the next reaction step, trivinyl(3-chloropropyl)silane (0.016 mol, 3 g) was converted to trivinyl(3-iodopropyl)silane by reaction of the product from the previous reaction with a 2-fold excess of sodium iodide (0.032 mol, 5.5 g) in acetone (25 mL) for 48 hours at 60° C. Following the reaction, the acetone was removed by rotary evaporation, and the product was then dissolved in chloroform (150 mL). The salt byproducts and impurities were then removed by vacuum filtration. The trivinyl(3-iodopropyl)silane product was then purified by vacuum distillation at 70° C. and 0.8 Torr. In the next initiator synthesis step, trivinyl(3-iodopropyl)silane (0.009 mol, 2.5 g) was converted to trivinyl(3-hydroxypropyl)silane by reacting the product from the previous reaction with HMPA (5 mL), sodium bicarbonate (0.009 mol, 0.76 g), and deionized water (0.009 mol, 1.5 mL) at 100° C. for 24 h. The product was extracted twice from the aqueous mixture with chloroform in a separatory funnel. The chloroform was evaporated by rotary evaporation, and the trivinyl(3-hydroxypropyl)silane product was purified by vacuum distillation at 90° C. and 0.8 Torr. Trivinyl(3-hydroxypropyl)silane was confirmed by ¹H NMR (CDCl₃): δ 0.71 ppm (2H), δ 1.65 ppm (2H), δ 3.51 ppm (2H), δ 5.70-6.18 (9H).

To complete the initiator synthesis, the trivinyl(3-hydroxypropyl)silane (0.0075 mol, 1.26 g) was reacted with potassium naphthalide (0.0071 mol, 7.5 mL of a 0.95 M solution of potassium naphthalide in THF) in 10 mL of THF under a heavy nitrogen purge to form the alkoxide initiator.

### Synthesis of trivinyl-poly(ethylene oxide)

The synthesis of a 4331 g mol⁻¹ trivinylsilylpropoxy-terminated poly(ethylene oxide) was done according to previously reported by Vadala, et al. (Biomacromolecules, 2008, 9, 1035-1043). A brief description of the synthetic route will be given here. Initially, a 300 mL Parr pressure reactor was cooled to −50° C. utilizing a liquid nitrogen/acetone bath. Ethylene oxide (0.341 mol, 15 g) was then distilled into the Parr reactor using a pressure and temperature gradient. The alkoxide trivinyl(3-hydroxypropyl)silane initiator solution was then added to the Parr reactor via syringe along with an additional aliquot of THF (10 mL). The liquid nitrogen/acetone bath was then removed from the reactor and the solution was allowed to warm to room temperature. The solution was then stirred for 24 hours. After reaction, the polymerization was terminated by the addition of acetic acid (0.0075 mol, 3 mL of a 2.5 M solution of acetic acid in THF) under nitrogen. The solution was then removed from the reactor and was precipitated into diethyl ether. The product was then redissolved into dichloromethane and washed twice with water. The solid product of trivinyl-poly(ethylene oxide) was then obtained by evaporating the solvent. Confirmed by ¹H NMR (CDCl₃): δ 0.72 ppm (2H), δ 1.64 ppm (2H), δ 3.42 ppm (2H), δ 3.35-3.90 (604H), δ 5.68-6.20 (9H). Molecular weight of the polymer was confirmed to be 4331 g mol⁻¹ using gel permeation chromatography (GPC) in chloroform using a calibration curve of PEO standards.

### Synthesis of tricarboxylic acid poly(ethylene oxide)

To create a tri-carboxylic acid terminated PEO, trivinyl-PEO (2 g, 0.462 mmol) created from the previous reaction was reacted with mercaptoundecanoic acid (0.303 g, 1.39 mmol) and AIBN (3.1×10⁻⁴ g, 1.89×10⁻³ mmol) in toluene at 80° C. for 2 hours. The solvent was then removed using a rotary evaporator and the product was redispersed into dichloromethane. The solution was then precipitated into ethyl ether and the final product of tricarboxylic acid terminated PEO (1.93 g, 0.38 mmol, 82.3% yield) was filtered and vacuumed dried overnight to remove any residual solvent.

### Synthesis of tri-N-hydroxysuccinimide poly(ethylene oxide)

The polymer synthesized in 2.3.5 was activated for reaction with an amine by reaction N-hydroxysuccinimide (NHS). In a typical reaction, tri-carboxylic acid terminated PEO (1.93 g, 0.38 mmol) was dissolved into 20 mL of chloroform. Dicyclohexylcarbodiimide (DCC, 2.99 g, 1.45 mmol) was then added to the solution and the mixture was allowed to stir for 1 hour. NHS (1.33 g, 1.2 mmol) was then added to the solution, and the mixture was then allowed to react for 4 hours. The solution was then filtered to remove impurities and precipitated with ethyl ether and vacuum dried overnight, resulting in the final product of tri-NHS terminated PEO (1.9 g, 0.358 mmol, 94.2% yield).

### Synthesis of tri-nitroDOPA poly(ethylene oxide)

In the final reaction step, the tri-NHS synthesized polymer was reacted with nitroDOPA to form a tri-nitroDOPA terminated polymer. In a typical reaction, tri-NHS PEO (1.9 g, 0.358 mmol) was dissolved into 10 mL of DMF under a heavy nitrogen purge. To this solution, nitroDOPA (0.26 g, 1.02 mmol) is added via syringe. The solution is allowed to react for 8 hours, and following reaction was precipitated using ethyl ether. The resultant white polymer with very light hint of yellow was then dissolved in chloroform and filtered to remove impurities. The chloroform solution was then precipitated with hexane and vacuum dried overnight resulting in the final product tri-nitro-DOPA terminated PEO (1.4 g, 0.245 mmol, 68.5% yield). The total reaction scheme is depicted in structures (I) through (V) of FIG. 1(b). NMR verified polymer modification by peaks appearing at 6.1 and 6.75 ppm (CH, ring, nitroDOPA), 2.7 ppm (triplets, CH₂—CH₂, nitroDOPA), 1.3 ppm (CH₂—CH₂ mercaptoundecanoic acid), and 3.65 ppm (O—CH₂—CH₂—O, PEO).

### Modification of Magnetite Nanoparticles

To transfer the as synthesized particles into hydrophilic media, the magnetite particles were modified with each of the synthesized polymers, as catechols have been demonstrated to have a high surface affinity. To do this, 0.025 mmol of each polymer was separately dissolved in 10 mL of chloroform. To this solution, 3 mL of the iron oxide nanoparticles in chloroform was slowly dripped (5-10 drops a minute) into the polymer solution under sonication. The particle solution had a concentration of 3.3 mg Fe per mL for a total of 10 mg of magnetite particle modified with each polymer set. Once all particle solution was added, the chloroform solution was allowed to sonicate for another 30 minutes. Following this, the particle/polymer solution was then placed on a shake plate overnight. Following complete reaction, the polymer-coated nanoparticles were precipitated from chloroform using hexane and collected using centrifugation. The polymer coated nanoparticles were then redispersed into water and dialyzed against water using a molecular weight cut-off of 14,000 g mol⁻¹ tube for 3 days to remove any unreacted polymer. Polymer modification was verified by infrared spectroscopy (FT-IR) by the presence of peaks at 1120 cm⁻¹ corresponding to the presence of PEO on the surface of magnetite.

### Example 1

### Procedure

To test the effectiveness of each of these ligands binding strength to surface of magnetite each polymer-coated system was introduced to the same synthetic biological conditions. This was accomplished by taking 5 mL each polymer-coated aqueous suspension and dialyzing against 250 mL of 1× (0.01 M) PBS for 48 hours, with 6 total PBS changes. Each particle/polymer suspension was then re-dialyzed into water after the 48 hour period to remove any unbound ligand and residual salts that may affect later measurements. To further monitor the stability of these systems, the hydrodynamic diameter of each of the polymer-coated systems was measured as a function of increasing PBS concentration and time in a 0.01 M solution of PBS. Time dependent studies were also conducted in fetal bovine serum (FBS) to monitor the time dependent stability of these systems in a protein rich environment.

### Transmission Electron Microscopy

Transmission Electron Microscopy (TEM) was used to obtain the core size of the particles used for this series. Samples were prepared by dropping diluted water solution of each polymer-particle complex onto copper grid coated with a carbon film. High resolution TEM images were acquired at an accelerating voltage of 300 kV on a Hitachi H-9500 instrument. Image analysis was performed using Adobe Photoshop® using Foveapro 4 plugin. Around 300 total particles were measured for each nanoparticle system produced.

### Thermal Gravimetric Analysis

Thermogravimetric analysis (TGA) was used to analyse the polymer loading on each nanoparticle series before and after a 48 hour dialysis with PBS. After this 48 hour period, each sample was then dialyzed against deionized water to remove any residual salts and unbound polymer from the system to not influence the observed weight loss in TGA. For each polymer-particle system, between 2 and 5 mg was evaporated onto a platinum TGA pan and then heated to 900° C. on a TA Instruments High Res 2950 instrument with a 15° C. min⁻¹ heating rate. The polymer loading burn off was then measured and compared to nanoparticle surface area to calculate the number or polymer chains per square nanometer of nanoparticle surface area before and after dialysis. For these calculations the char yield of PEO was measured and was determined to be negligible and any mass left after 700° C. was considered to be the inorganic magnetite. The reduction of polymer chains per square nanometer was recorded (see Table 1).

### Dynamic Light Scattering

Dynamic Light Scattering (DLS) was used to identify the hydrodynamic diameter of each of the PEO coated particles in the series. Intensity average size in DLS can be a good indication of particle stability and clustering, and readings were taken as a function of PBS concentration to gain an understanding of the extent of clustering in each system induced by increased PBS concentration. To do this, each polymer-coated suspension was diluted to 0.1 mg Fe per mL, and then increasing volumes of 1×PBS was titrated into each sample. The volume added to each 1 mL sample particle solution was 0.1 mL, 0.5 mL, and 1 mL for a final PBS concentration of 10% (v/v), 33% (v/v), and 50% (v/v). Measurements were made after a 5-minute equilibrium time to allow diffusion of PBS throughout each sample. Measurements were conducted using a Malvern Zetasizer Nano ZS using water as the solvent at 25° C. For the 100% PBS sample, a 1 mL aliquot was taken of each sample and dialyzed against 1×PBS for 48 hours. It is important to note that the pH is an important factor to understand when measuring particle stability, and the pH of the 1× stock solution of PBS utilized was measured to be 7.4. The pH of each of the concentration series samples were then sequentially measured, and the pH had minor variations between 7.1 and 7.4. In addition to observing surface charge as a function surface modification, zeta potential measurements were made in DI water at a concentration of 0.1 mg Fe per mL.

### Time Dependent Stability Measurements

Time dependent measurements were used to determine the stability of these polymer suspensions in biological media as a function of time. To do this, 0.1 mL of 10×PBS was added to 0.9 mL of each polymer-coated magnetite suspension at 0.1 mg Fe per mL. The Z-average hydrodynamic size is reported as a function of time over 24 hours. The Z-average size is used here because it gives the mean diameter of the intensity average hydrodynamic size. To further test the time dependent stability of these suspensions, the Z-average hydrodynamic size was measured as a function of time in FBS. Samples were prepared by adding 0.1 mL of FBS to 0.9 mL of each particle suspension at 0.1 mg Fe per mL, creating a 10% by volume solution of FBS.

### Results

The stability of polymer-coated magnetite nanoparticles inside synthetic biological conditions was tested here so that the effectiveness of a multi-anchor group polymer could be compared to monofunctional polymers. To investigate the potential loss of particle surface coating ligands, the loss of polymer surface coating density was determined using TGA before and after dialysis against PBS for 48 hours. To investigate if PBS significantly altered the stability of these systems, the hydrodynamic diameters of these systems were measured as a function of PBS concentration. PBS was used for this study because it is a common physiological buffer and has been shown to interfere with the colloidal stability of nanoparticles in solution. To further investigate the stability of these suspensions in synthetic biological media, the hydrodynamic size of each suspension was measured as a function of time in both PBS and FBS. To calculate the surface coverage of ligands based upon the weight loss from TGA, and to compare measured particle sizes from DLS to theoretical hydrodynamic diameters, the blob model as reported by Mefford, et al. (Langmuir, 2008, 24, 5060-5069) was used, which will be described in more detail below.

### TEM

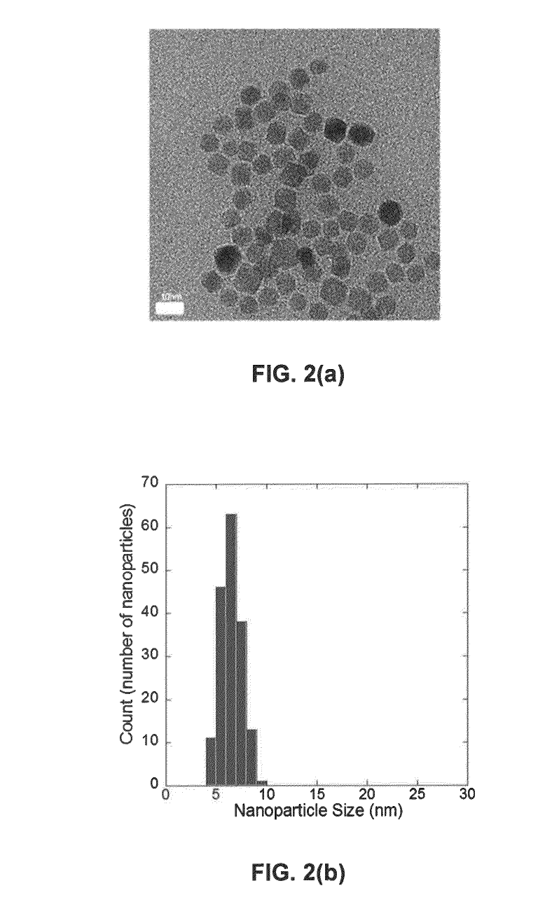

The mean particle size of the magnetite nanoparticle solution created from the thermal decomposition of iron(acac)₃ in the presence of oleylamine and benzyl ether used in this study was determined from TEM to be 6.5 nm with a numerical standard deviation of ±1.05 nm (FIG. 2). Several aliquots of sample were measured along with multiple positions on the TEM grid to ensure particle size accuracy.

### Calculations of Polymer Brush Size and Density

One of the more important factors for this study is to analyze the cluster formation of each polymer-particle system as a function of PBS concentration. This is based off the assumption that as PBS displaces the surface coating, the steric repulsion mechanism decreases, therefore decreasing overall particle stability and increasing the observed amount of clustering in the system. To accomplish this, the measured hydrodynamic diameter must be compared to theoretical expectations. For these systems, the theoretical hydrodynamic diameter calculated using the blob model, which is based on a model for star polymers by Daoud and Cotton (J. Phys., 1982, 43, 531-538) and assumes concentric shells with a constant number of blobs in each shell. Using this model, the hydrodynamic diameter of each polymer-particle system can then be calculated by:

$${R}_{m} ( r ) = {( \frac{8 {N}_{k} {f ( r )}^{1 - v / 2 v}}{3 \times {4}^{1 / v} \times v} {{L}_{k}}^{1 / v} + {r}^{1 / v} )}^{v} \qquad ( 1 )$$

where n is the Flory exponent (0.583 for PEG in water), r is the radius of the magnetite particle, and Nₖ is the number of Kuhn segments in one of the corona chains, Lₖ is the Kuhn segment length, (0.7 nm), 35 and f(r) is the number of corona chains per particle. The number of Kuhn segments is defined by:

Nₖ=n/c_{∞} (2)

where n is the number of backbone bonds in a chain (3*degree of polymerization for PEG), and c_{∞} is the characteristic ratio of PEG (4.1). The Kuhn segment length, Lₖ, is defined as:

Lₖ=c_{∞}l₀ (3)

where l₀ is the average length of a backbone bond (0.17 nm), f(r) is the number of corona chains per particle, which can be calculated using the equation:

f(r)=4πr²σ (4)

where s is the surface density of chains on each particle. Using this model, the theoretical hydrodynamic diameter can be calculated and compared to measured particle sizes from DLS to gain an understanding of the degree of clustering in the polymer-particle system, as shown in (Table 1). It is assumed that when measured particle sizes by DLS are significantly larger than what is predicted from the blob model, significant clustering or agglomeration of the particles is occurring.

Table 1, shown below, compares each of the polymer-coated particles in the series. Comparisons are made between the initial measured hydrodynamic diameter and what is calculated from the blob model. Surface coverage values are also compared between sample for before and after dialysis against PBS for 48 hours.

TABLE 1

| | | 50% | | | | | | | |
|---|---|---|---|---|---|---|---|---|---|
| | Initial Measured | PBS Intensity | | | Initial | Initial Surface | | After PBS | Polymer |
| | Intensity | Average | Caclulated | | Mass | Coverage | After PBS | Surface | Chains |
| | Average | Hydrodynamic | hydrodynamic | Total MW | Loss | (chanis per | Mass | Coverage | Removed |
| Sample Name | Diameter (nm) | Diameter (nm) | diameter (nm) | (g mol⁻¹) | (%) | nm²) | Loss (%) | (chains per nm²) | (%) |
| PEO-DOPA | 39.7 | 53.4 | 37.5 | 5197 | 74.6 | 1.7 | 66.7 | 1.2 | 32.2 |
| PEO-NDOPA | 89.6 | 44.3 | 36.7 | 5242 | 72.4 | 1.5 | 66.4 | 1.17 | 25 |
| PEO-triNDOPA | 68.7 | 73.8 | 44.8 | 5712 | 88.2 | 4.1 | 87.3 | 3.75 | 8.1 |

### TGA

To observe the effect of biological media on nanoparticle surface coverage and ligand removal, each of the three polymer-coated samples were dialyzed against PBS for 48 hours, TGA was used to determine the surface coverage of polymer in each system before and after dialysis to determine the amount of polymer removed (Table 1). It can be seen from the TGA results that the PEO-DOPA and PEO-nitroDOPA coated samples had very similar initial surface coverage. The PEO-DOPA had a higher surface coverage than the PEO-nitroDOPA, which is most likely because of the increased steric repulsion between polymer anchor groups in the nitroDOPA sample from the addition of the nitro group. The PEO-tri-nitroDOPA sample had the highest initial surface coverage, which is attributed to the multiple attachment points and higher difficulty in removing polymer during dialysis. After dialysis with PBS for 48 hours, both PEO-DOPA and PEO-nitroDOPA had significant amounts of polymer removed. For the PEO-DOPA sample, a reduction in the surface coverage of 32.2% was observed. For the PEO-nitro-DOPA sample, a reduction of 25% of the surface coverage was observed. This is compared to the PEO-tri-nitroDOPA sample, which only exhibited an 8.1% reduction in surface coverage was observed. The retention of surface coating density is extremely important in biological media, as significant reduction of the polymer loading can significantly lower the steric repulsion of these particles, instigating agglomeration and eventual flocculation. From this data, it can be deduced that PEO-tri-nitroDOPA is a significantly more robust polymer coating than its counterparts, with very little influence exerted upon it by biological media and salts.

### Zeta Potential Measurements

To characterize the surface potential of the modified magnetic nanoparticles, zeta potential measurements were made for the three different aqueous suspensions. The PEO-DOPA, PEO-nitroDOPA, and the PEO-tri-nitroDOPA had zeta potentials of 4.7, −5.1, and −12.2 mV, respectively. These near neutral surface charges indicate that electrostatic repulsion is not a major mechanism of the colloidal stability of these materials.

### DLS

For each polymer-coated sample, DLS was used to determine particle hydrodynamic diameter as a function of PBS concentration. Intensity weighted hydrodynamic sizes given by DLS, while not a perfect indication of particle stability, can give a good insight on how PBS concentrations influence the average particle hydrodynamic diameter. This information, when compared to calculated theoretical particle size calculated from the blob model, (Table 1) can give a good indication of the degree of clustering in the system as a function of PBS concentration.

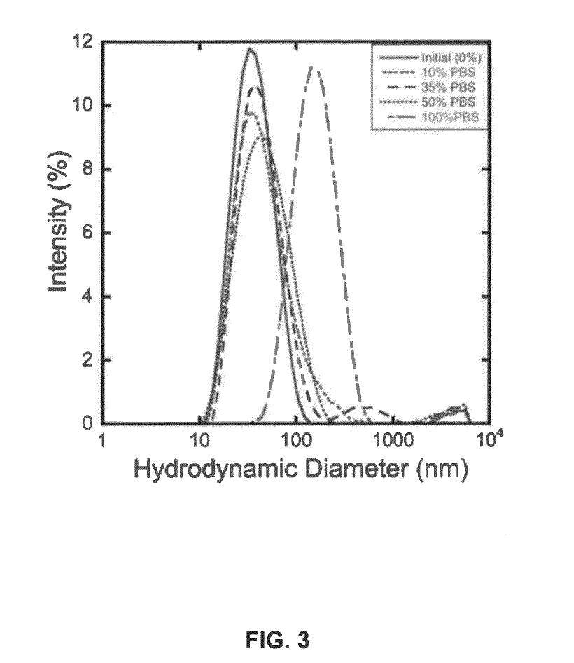

Over the course of this DLS study it was observed that particle stabilized with multi-anchor ligands were significantly more stable that their single functionality counterparts, which is expected because ligands with more attachment points having a greater ability to withstand displacement by biological salts. Multiple attachment points favors the steady state equilibrium of ligands bound to the surface of particles. The partial removal of one of many anchor groups limits the diffusion of whole ligands away from the surface as other attachment points remain. For the PEO-DOPA sample (FIG. 3), particles in deionized water were measured to have a hydrodynamic diameter of 39.7 nm nanoparticles used for this study. The initial predicted hydrodynamic diameter for this sample based upon the polymer surface coverage from TGA using the blob model was 37.5 nm. This indicates that these particles initially are discrete with no clustering present. The intensity average size of the particle complex increased with increasing PBS concentration, with a hydrodynamic diameter of 53.4 nm at 50% PBS. To achieve 100% PBS, the PEO-DOPA coated particles were dialyzed against PBS for 48 hours. After dialysis the hydrodynamic diameter of the system was significantly increased, with severe flocculation occurring. From the total DLS results (FIG. 3), which contain both the titration study and the final particle size after a 48-hour dialysis against PBS, it can be seen that the hydrodynamic size of the PEO-DOPA coated particles increases significantly with PBS concentration. It can also be observed that secondary peaks form above 300 nm for higher concentrations PBS, indicating these particles form large aggregates at higher concentrations of PBS. There is a large shift in the intensity average size for this sample when dialyzed against PBS for 48 hours (100% PBS), resulting in significantly less stable particles. These results along with comparisons to theoretical calculations indicate that magnetite nanoparticles coated by a PEO-DOPA polymer are influenced significantly by PBS with long range clusters forming at higher concentrations of PBS.

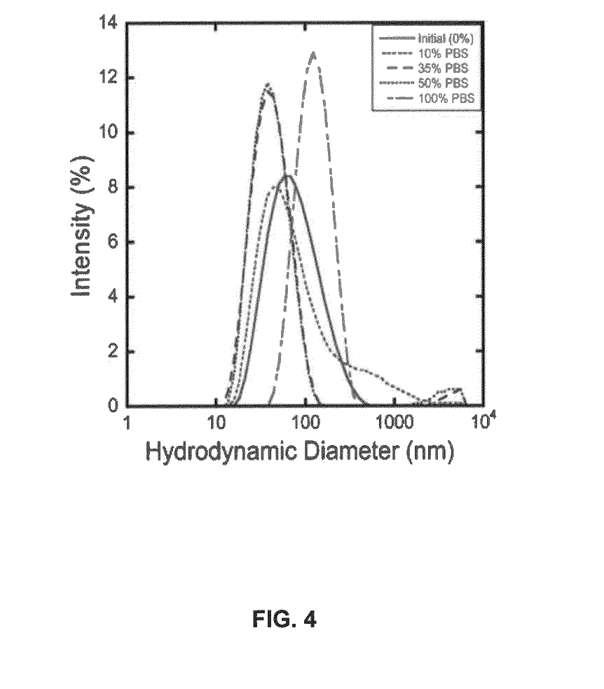

For the PEO-nitroDOPA coated particles (FIG. 4), significant clustering was observed in the initial particles before introduction to PBS, which was unexpected. The initial recorded hydrodynamic diameter was 89.6 nm. Since the initial calculated hydrodynamic size based upon the polymer coating calculated from TGA is 36.7 nm, it can be determined that significant clusters are present initially. When varying concentrations of PBS were introduced to the system, the main hydrodynamic diameter peak from DLS decreased. The hydrodynamic diameter recorded at 50% PBS was 44.3 nm. However, even though the results indicate an increase in particle stability as a function of PBS concentration, a closer examination reveals that there are significant peaks past 1000 nm at higher concentrations of PBS, indicating the formation of large aggregates, similar to what was observed in the PEO-DOPA coated samples. The initial peak likely is composed of both discrete and slightly clustered particles. As PBS is introduced into the system these initial aggregates are likely more susceptible to additional agglomeration. Also, much like what was observed in the PEO-DOPA sample, a significant shift in the intensity average hydrodynamic diameter was seen in the PEO-nitroDOPA sample after dialysis against PBS for 48 hours. This data suggests that much like PEO-DOPA, PEO-nitroDOPA particles are significantly influenced by the presence of PBS.

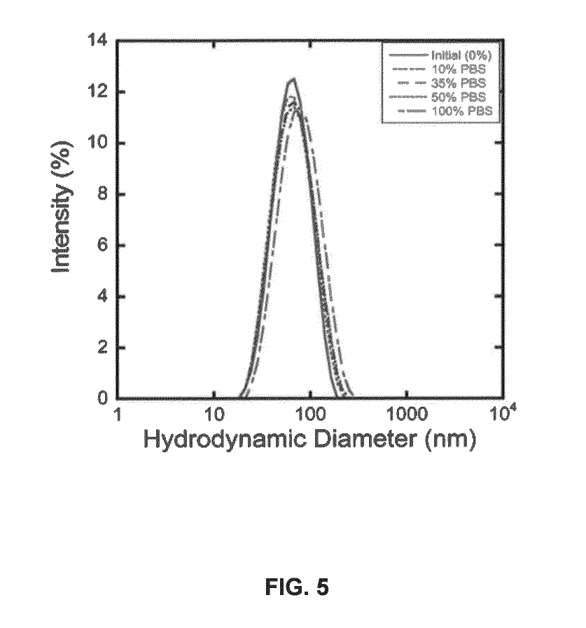

For the final sample, the stability of PEO-tri-nitroDOPA particles was measured as a function of increasing PBS concentration (FIG. 5). The initial measured hydrodynamic diameter was 68.7 nm, which is compared to a calculated hydrodynamic diameter of 44.8 nm. The larger calculated hydrodynamic diameter for this sample is because compared to its single anchor counterparts, PEO-tri-nitroDOPA has a significantly higher surface coverage. The hydrodynamic diameter of the 50% PBS solution was 73.8 nm, which is compared to a final calculated hydrodynamic of 44.11 nm. This indicates an increase in hydrodynamic diameter of 7.33%. Of the three polymer ligands tested, PEO-tri-nitroDOPA has the smallest increase in particle hydrodynamic diameter as a function of increasing PBS concentration. Furthermore, no long range aggregates form even at the highest concentration of PBS. This indicated that PEO-tri-nitroDOPA coated nanoparticles are very stable in biological media with only a slight change in the hydrodynamic diameter with increasing PBS concentration. For this sample, the measured particle size was about 35% larger than what was calculated, which would normally indicate the presence of initial clustering. However, it can be speculated that the reason for the difference between measured and calculated values for this sample are due to inadequacies in the blob model in accounting for the inner hydrophobic layer. This may be an accurate hypothesis based upon the fact that particle size from DLS remained constant amongst multiple samples. Furthermore, this sample showed very little size change after dialysis against PBS for 48 hours, indicating that unlike PEO-DOPA and PEO-nitroDOPA, the stability of PEO-tri-nitro-DOPA coated particles is only minimally influenced by the presence of PBS.

### Time Dependent Stability Studies

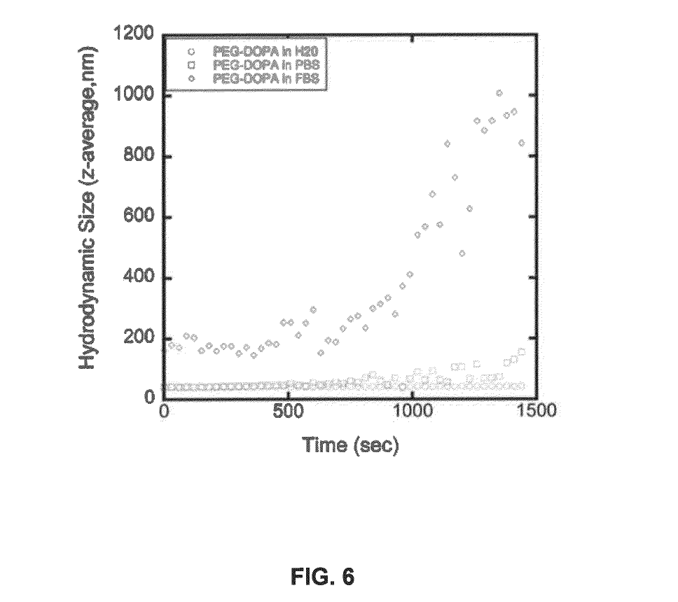

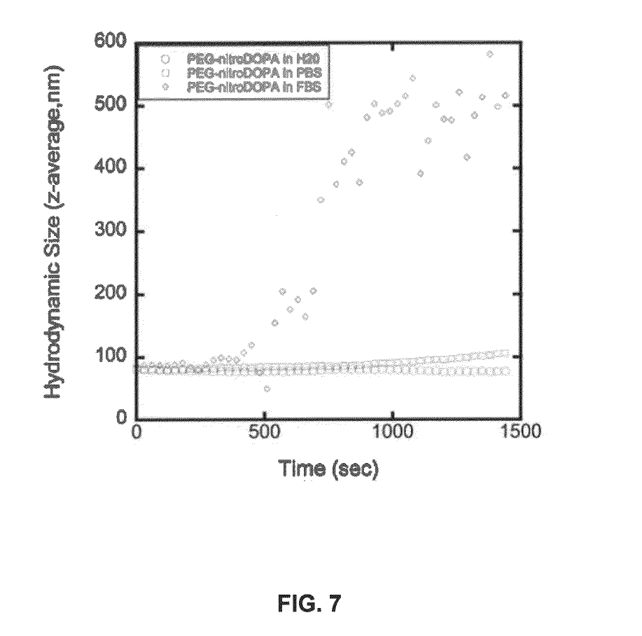

To further test the stability of these suspensions, the hydrodynamic size of each suspension was recorded as a function of time in both PBS and FBS. For the PEO-DOPA coated magnetite suspension, the hydrodynamic diameter of the sample was dramatically influenced by the presence of both PBS and FBS over time (FIG. 6). In the 24-hour period, the Z-average hydrodynamic diameter tripled in size as compared to the same sample in deionized water, showing signs of both clustering and sedimentation. This effect was further exaggerated in the FBS study, where the sample showed signs of heavy clustering and sedimentation after 6 hours. These results indicated that both PBS and FBS could readily displace ligands with an L-DOPA anchor and overall interfere with its ability to sterically stabilize magnetite nanoparticles. This effect was also seen in the nanoparticles stabilized using nitroDOPA anchor groups, but less dramatically (FIG. 7). In the 24 hour time period in PBS, the Z-average hydrodynamic size of the PEO-nitroDOPA sample roughly doubled in size as compared to the sample in deionized water over the same time frame. Once again, the hydrodynamic diameter of this system was severely influenced by the presence of FBS, with significantly clustering observed after 6 hours. This technique of measuring the influence of PBS on the nitroDOPA anchor group did not display the same effect in earlier studies where the main peak hydrodynamic size decreased as a function of PBS concentration, as this study displayed steady hydrodynamic size increase as a function of time.

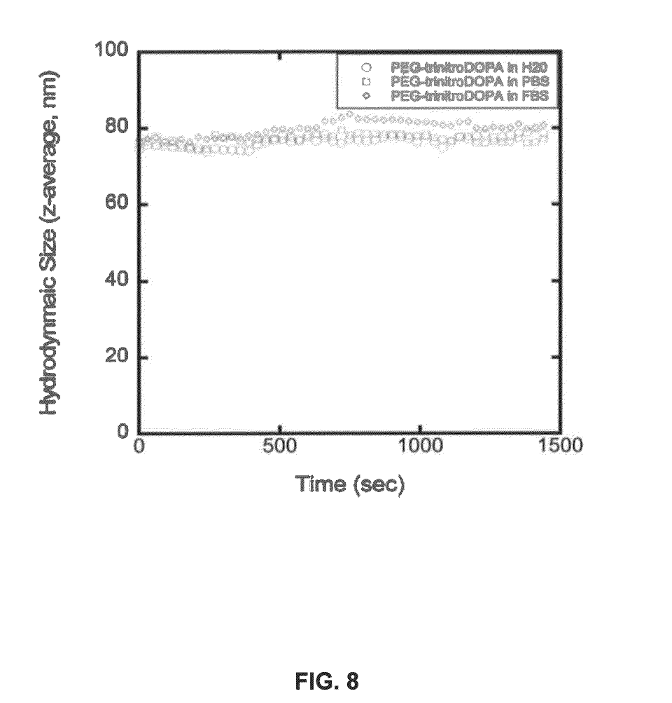

For the magnetite stabilized with PEO-tri-nitroDOPA, the effect of PBS on hydrodynamic size and particle stability was minimal (FIG. 8). The sample showed a 2 nm size change over the 24 hour time period and did not display any visual signs of sedimentation. This was also the case with time dependent studies conducted with FBS, with a Z-average hydrodynamic size change of 5 nm. The sample also showed no visible signs of sedimentation, and remained suspended in solution for up to a week after the time dependent studies were conducted. This evidence further proves that multi-anchor nitroDOPA polymers are able to stabilize magnetite nanoparticles significantly more than their monofunctional counterparts.

### Summary

Three different polymer systems were tested in Example 1, as discussed above, to observe their ability to stabilize magnetite nanoparticles and withstand displacement by biological media. Ligand performance was determined by variations in TGA weight loss and variations in hydrodynamic size from titrations with PBS as determined by DLS. Over the course of this study it was determined that PEO-tri-nitroDOPA is capable of stabilizing magnetite nanoparticles, and has a high resistance to be being displaced by PBS. Its stability in PBS is comparable to tri-phosphanoate polymers discussed earlier, with both polymers showing little decrease in polymer surface coverage or clustering in PBS over 24 hours. Further investigation is needed to fully determine which polymer is a more robust anchor to magnetite nanoparticles. PEO-DOPA and PEO-nitroDOPA performed poorly, each losing significant amounts of the polymer coating by displacement of polymers by PBS. The stability of the PEO-DOPA coated particles decreased significantly as PBS and FBS was added to the system, with both an increase and broadening of the intensity average hydrodynamic size as well as formation of larger long range clusters. It is therefore concluded that of these polymers tested, PEO-tri-nitroDOPA is the most effective at stabilizing magnetite nanoparticles in biological media and retaining stability.

### Examples 2-9

In Examples 2-9 below, a similar method for coating metal nanoparticles as discussed above in reference to Example 1 was utilized, along with other coating methods, to determine the impact of such coatings on the ability of the metal nanoparticles to disperse and/or reduce biofilms.

### Materials and Test Procedures for Examples 2-9

### Nanoparticle Formation

First, the metallic nanoparticles were formed as discussed below in reference to each of the examples. The nanoparticles in each of the examples were characterized in their stock solution and in moderate hard water (MHW) having a pH of about 7.7, a hardness of about 80 milligrams CaCO₃ per liter, and an alkalinity of 60 milligrams CaCO₃/liter using transmission electron microscopy (TEM), zeta potential and dynamic light scattering (DLS) to verify the size and stability of the particles. For TEM, the nanoparticles were pipetted onto a formvar carbon coated copper grid (Electron Microscopy Sciences) for imaging. The Malvern ZetaSizer Nano ZS was used to measure zeta potential and DLS at concentrations that gave optimal measurement conditions. Zeta potential was measured to determine the surface charge on the particle in solution. In most systems, a zeta potential of more negative than −30 mV denotes a stable system.

Stock solutions were measured as synthesized, with the exception of the Fe₃O₄ nanoparticle solution. This solution had to be diluted in ultrapure water (UPW) at a concentration of 6.5 milligrams per liter because the original stock solution was very concentrated. The nanoparticles were added to MHW at concentrations ranging from 0.650 milligrams per liter to 6.5 milligrams per liter for optimal measurement conditions. All DLS and zeta potential measurements were performed in duplicate immediately after the nanoparticles were added.

### Biofilm Establishment and Treatment

The establishment of the biofilm and subsequent treatment for each of the examples is discussed below. For examples 2-9, the biofilm tested was formed from Legionella pneumophila as the model organism. Legionella pneumophila strain Philadelphia 1 (ATCC 33152) was cultured on buffered charcoal yeast extract (BCYE) agar (VWR) at 37° C. and sampled from the agar plate after 3 days of incubation. For all initial experimental optical density (OD) measurements, L. pneumophila was suspended from the agar plate in ACES-buffered yeast extract (AYE) broth. Legionella pneumophila from a 3 day BCYE plate was used to make a bacterial suspension in AYE having an optical density of 0.6 at 600 nanometers. 4 milliliters of bacterial suspension was then added to 20 milliliters of 10% AYE to initiate biofilm attachment on a glass slide in a petri dish. After 24 hours, the supernatant was gently removed and replaced with 100% AYE. Each biofilm was allowed to incubate for 4 additional days at 26° C., which resulted in a mature L. pneumophila biofilm. On day 5, the biofilms were washed gently with ultrapure water (UPW) to remove any surface biofilm and unattached cells. For examples 2-6 the metallic nanoparticles were added at a concentration of 1 microgram/liter, 100 micrograms/liter, or 1000 micrograms/liter of moderate hard water (MHW) having a pH of about 7.7, a hardness of about 80 milligrams CaCO₃ per liter, and an alkalinity of 60 milligrams CaCO₃/liter as shown. For examples 7-9, the nanoparticles were added at a specific concentration as described below, and a biocide was also added at a specific concentration as described below. The biofilms were incubated for 48 hours at 26° C. On day 7, the biofilms were washed with UPW, air dried, and fixed in methanol for 10 minutes. Slides containing biofilms were stained with 3 micromolar (μM) Syto 11 (Invitrogen) nucleic acid stain in UPW for 30 minutes and then rinsed. Glycerol:Phosphate Buffered Saline (PBS) (50/50 v/v) was used as a mounting medium and slides were imaged at 60× magnification using a Nikon TiE Eclipse Confocal Microscope. At least six independent replicates were completed for each example. For example 9, a portion of the biofilms were incubated for 5 days post-treatment and on day 12 the procedure for day 7 above was repeated to compare the biofilm control (no treatment) with biofilms treated with nanoparticles, biocide, or a combination of nanoparticles and biocide to determine the fold increase in biomass.

### Image Analysis

Confocal images were analyzed using the program COMSTAT which comprises ten features for quantifying three-dimensional biofilm image stacks, and the bio-volume and roughness coefficients of the biofilms were examined. The program is described in the following publication: Heydorn, A., Nielsen, A. T., Hentzer, M., Sternberg, C., Givskov, M., Ersboll, B. K. & Molin, S. 2000, “Quantification of biofilm structures by the novel computer program COMSTAT,” Microbiology (Reading, England), vol. 146 (Pt 10), no. Pt 10, pp. 2395-2407.

Bio-volume is estimated through the biomass of the biofilm, which is determined by the number of pixels containing bacteria in all images of a stack multiplied by the voxel size, divided by substratum area of the stack. Meanwhile, the roughness coefficient of a biofilm provides a measure of how much the thickness of the biofilm varies and is an indicator of biofilm heterogeneity. An increased roughness coefficient, for instance, corresponds with cells being lost from the biofilm.

### Statistical Analysis

A one way analysis of variance was used to compare bio-volume and roughness coefficient of control, 1 micrograms/liter, 100 micrograms/liter, and/or 1000 micrograms/liter treatments for each type of nanoparticle. A one way ANOVA was also used to compare biomass, pigment production, and cell viability for controls and treatments separately for each time point for the platinum nanoparticles. When significant differences were found among treatments, Fisher's Least Significant Difference (LSD) was used to judge which treatments significantly differed from the others. A significance level of p<0.05 was used for all tests. Asterisks on graphs show statistically significant differences.

### Example 2

In Example 2, citrate-coated platinum nanoparticles having a particle size of 6 nanometers (nm) in diameter were formed by the following method. 50 milliliters (mL) of a 5.0 millimolar (mM) solution of trisodium citrate dihydrate (ACS Grade, Sigma Aldrich) was prepared in deionized (DI) water. To this solution, 0.2 mL of 0.05 molar (M) platinum chloride hexahydrate (H₂Cl₆Pt)(VWR) in DI water was added, followed by 0.5 mL of 0.05 M sodium borohydride (NaBH₄, VWR) in ice cold water. The mixture was stirred for 15 minutes and resulted in stable citrate-coated platinum nanoparticles.

TEM of the platinum nanoparticles demonstrated that the nanoparticles have an average diameter of 6.12 nm with a standard deviation of 1.96 nm. DLS reported a z-average size of 11.68 nm, and an intensity mean of 147.80 nm.

The platinum nanoparticle stock solutions had a zeta potential of −57.5 millivolts (mV). When added into moderate hard water (MHW), the zeta potential increased to −29.8 mV. In most systems, a zeta potential more negative than −30 mV denotes a stable system, suggesting that these nanoparticles are still moderately stable when initially added to MHW.

Testing results from Example 2 are shown in FIGS. 9(a) through 9(e). COMSTAT analysis of biofilms after exposure to 1 μg/L of 6 nm platinum nanoparticles shows a decrease in biofilm bio-volume, see FIG. 9(a), and an increase in roughness coefficient, see FIG. 9(b). Fluorescent confocal images show a control biofilm, see FIG. 9(c), and significant loss of biofilm after exposure to 1 μg/L 6 nm platinum nanoparticles, see FIG. 9(d), but not after exposure to 100 μg/L 6 nm platinum nanoparticles, see FIG. 9(e).

In Example 2, after 7 days of treatment with 1 microgram/liter of citrate-coated 6 nm platinum nanoparticles, the biofilm had a reduction in bio-volume of from about 1.6 μm³/μm² to about 1.0 μm³/μm². Meanwhile, when a higher concentration of nanoparticles was applied (100 μg/L), the biofilm bio-volume was not reduced and shows a slight increase to about 1.7 μm³/μm². This is observed in a comparison of FIG. 9(d), which shows a biofilm 7 days after treatment with 1 μg/L of 6 nm platinum nanoparticles, with FIG. 9(e), which shows a biofilm 7 days after treatment with 100 μg/L of 6 nm platinum nanoparticles. There is a greater amount of dispersion in the biofilm of FIG. 9(d) compared to FIG. 9(e).

Further, after 7 days of treatment, both the biofilm treated with 1 μg/L of platinum nanoparticles and the biofilm treated with 100 μg/L of platinum nanoparticles showed an increase in roughness coefficient, indicating the thickness of the biofilm was not uniform, which is indicative of biofilm dispersion and cell loss. The roughness coefficient for the untreated biofilm was about 0.5, while the roughness coefficient for the biofilm treated with 1 μg/L of platinum nanoparticles was about 0.9 and the roughness coefficient for the biofilm treated with 100 μg/L of platinum nanoparticles was about 0.6.

### Example 3

In Example 3, citrate-coated silver nanoparticles having a particle size of 8 nm in diameter were formed by the following method. 0.125 mL of a 0.1 M solution of trisodium citrate dehydrate and 0.125 mL of 0.1 M silver nitrate (AgNO₃) (Alfa Aesar) were added to DI water. Then, 0.25 mL of 0.05 M iced NaBH₄ was added. The mixture was stirred for 15 minutes and resulted in stable citrate-coated silver nanoparticles.

TEM of the silver nanoparticles demonstrated that the nanoparticles have an average diameter of 7.76 nm with a standard deviation of 3.55 nm. DLS reported a z-average size of 17.93 nm, and an intensity mean of 40.58 nm.

The silver nanoparticle stock solutions had a zeta potential of −64.5 mV, but when they were added into MHW the zeta potential increased to −9.7 mV, suggesting possible aggregation in the ionic MHW exposure medium and instability.

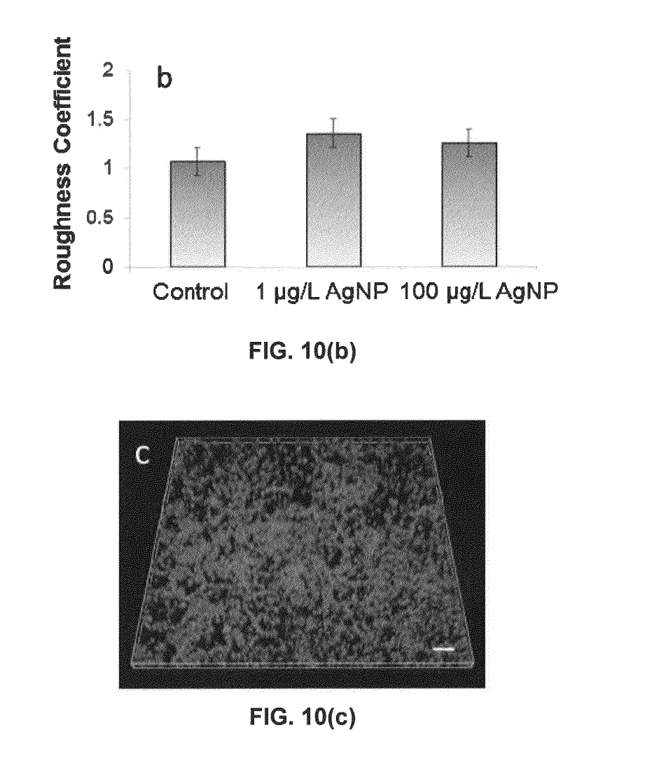

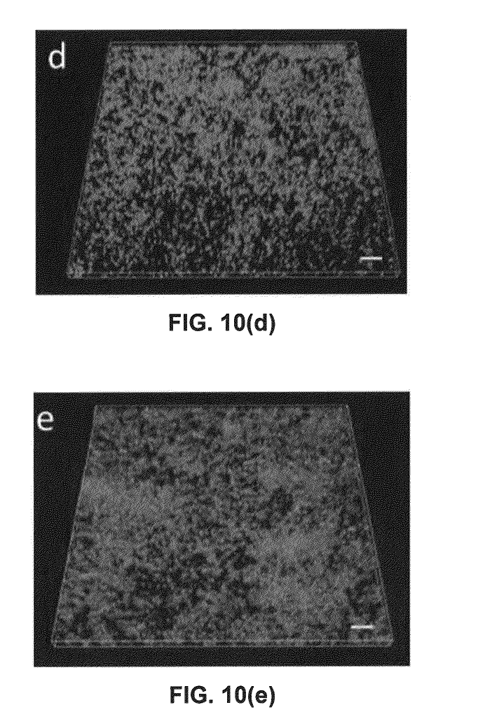

Testing results from Example 3 are shown in FIGS. 10(a) through 10(e). COMSTAT analysis of biofilms after exposure to 1 μg/L 8 nm silver nanoparticles and 100 μg/L 8 nm silver nanoparticles shows no statistical difference in bio-volume, see FIG. 10(a), or roughness coefficient, see FIG. 10(b), compared to controls, although there was an observed decrease in bio-volume and increase in roughness coefficient. Fluorescent confocal images show a control biofilm, see FIG. 10(c), and biofilms after exposure to 1 μg/L of 8 nm silver nanoparticles, see FIG. 10(d), and 100 μg/L of 8 nm silver nanoparticles, see FIG. 10(e). After exposure to the silver nanoparticles, the loss of biofilm is not as great for the silver nanoparticles as compared to the platinum nanoparticles of Example 2 (FIG. 9).

In Example 3, after 7 days of treatment with 1 microgram/liter of citrate-coated 8 nm silver nanoparticles, the biofilm had a reduction in bio-volume of from about 1.5 μm³/μm² to about 1.1 μm³/μm². Meanwhile, when a higher concentration of nanoparticles was applied (100 μg/L), the biofilm bio-volume was reduced to about 1.2 μm³/μm². This is observed in a comparison of FIG. 10(d), which shows a biofilm 7 days after treatment with 1 μg/L of 8 nm silver nanoparticles, and 10(e), which shows a biofilm 7 days after treatment with 100 μg/L of 8 nm silver nanoparticles, where there is more dispersion in FIG. 10(d) as compared to 10(e).

Further, after 7 days of treatment, both the biofilm treated with 1 μg/L of silver nanoparticles and the biofilm treated with 100 μg/L of silver nanoparticles showed a slight increase in roughness coefficient, indicating the thickness of the treated biofilms were not uniform, which is indicative of biofilm dispersion and cell loss. The roughness coefficient for the untreated biofilm was about 1.0, while the roughness coefficient for the biofilm treated with 1 μg/L of silver nanoparticles was about 1.3 and the roughness coefficient for the biofilm treated with 100 μg/L of silver nanoparticles was about 1.2.

### Example 4

In example 4, PEG-tri-nitroDOPA coated Fe₃O₄ particles having a particle size of 6.7 nanometers (nm) in diameter were formed by the following method. First. 6.7 nm diameter particles were produced by adding 0.35 grams of 1 mM iron (Ill) acetylacetonate (Fe(acac)₃) and 2.5 mL of 17.09 mM oleylamine (OAm) to 17.5 mL of benzyl ether in a round bottom flask under a nitrogen blanket. The solution was then heated at 3° C. per minute to 300° C. and held isothermally for 1 hour. The particles were purified by repeated washing with ethanol and centrifugation. Then the particles were coated with PEG-tri-nitroDOPA, which was formed as discussed above. To coat the nanoparticles, 0.025 mM of each polymer was separately dissolved in 10 mL of chloroform. To this solution, 3 mL (10 milligrams of particles at a concentration of 3.3 mg/mL) of the 6.7 nm Fe₃O₄ (magnetite) solution was slowly dripped (5-10 drops a minute) into the polymer solution under sonication. Once all particle solution was added, the chloroform solution was allowed to sonicate for another 30 minutes. Following this, the particle/polymer solution was then placed on a shake plate overnight. After a complete reaction, the polymer coated nanoparticles were precipitated from chloroform using hexane and collected using centrifugation. The polymer coated nanoparticles were then redispersed into water and dialyzed against water for 3 days to remove any unreacted polymer. This resulted in stable, PEG-tri-nitroDOPA coated Fe₃O₄ nanoparticles.

TEM of the PEG-coated Fe₃O₄ nanoparticles demonstrated that the nanoparticles have an average diameter of 7.35 nm with a standard deviation of 1.56 nm, DLS reported a z-average size of 73.11 nm using DLS and an intensity mean of 86.89 nm. This increase in size was expected due to the large polyethylene glycol (PEG) polymer used to coat the surface of the nanoparticles.

The Fe₃O₄ nanoparticles are stabilized by a neutral PEG coating which provides steric stabilization in contrast to the ionic stabilization provided by the citrate coating in Examples 2 and 3. Therefore, the zeta potential is expected to be close to 0 because there is no charge on the particle. The Fe₃O₄ NPs had a zeta potential of −15.4 mV, which shifted to −5.37 mV after addition to MHW.

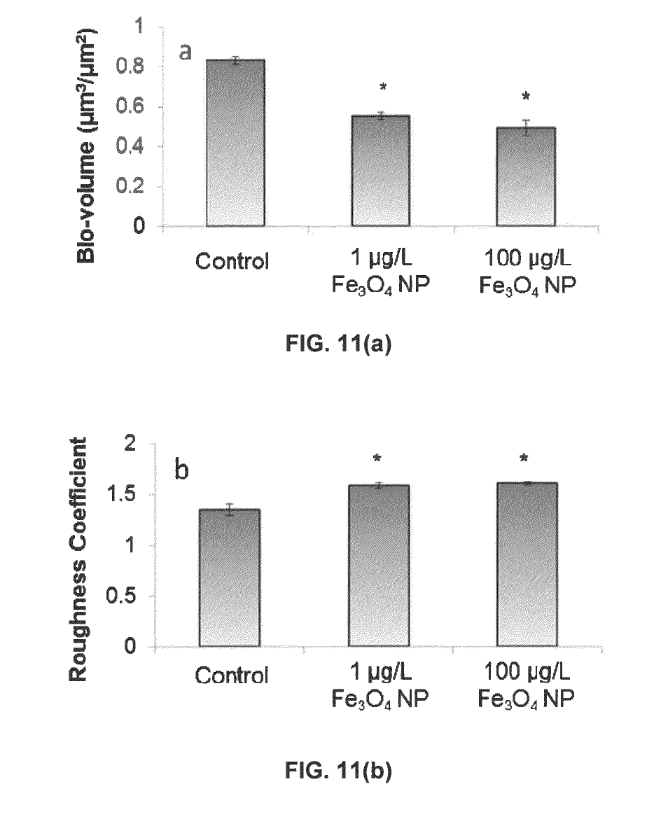

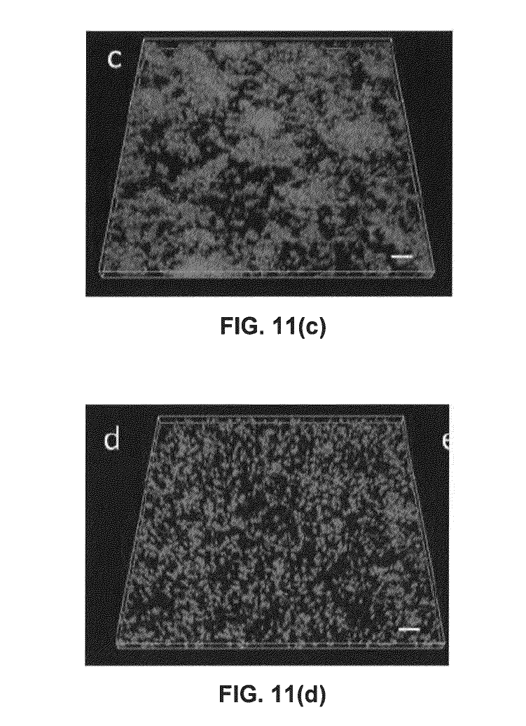

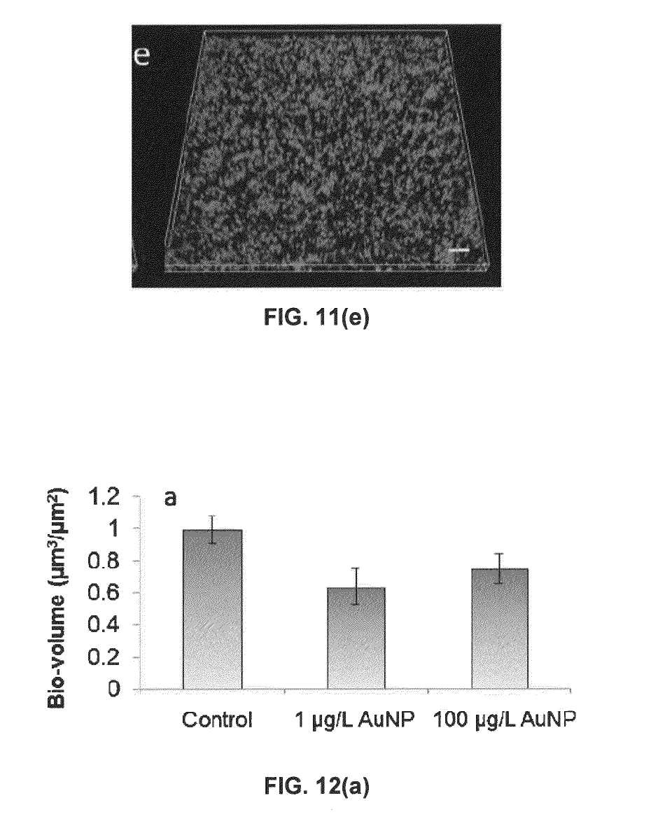

Testing results from Example 4 are shown in FIGS. 11(a) through 11(e). COMSTAT analysis of biofilms after exposure to 1 and 100 μg/L of 8 nm Fe₃O₄ NPs shows a statistically significant decrease in biofilm bio-volume, see FIG. 11(a) and an increase in roughness coefficient, see FIG. 11(b), compared to controls. Fluorescent confocal images show a control biofilm, see FIG. 11(c), and significant loss of biofilm after exposure to 1 μg/L of 8 nm Fe₃O₄ nanoparticles, see FIG. 11(d), and 100 μg/L of 8 nm Fe₃O₄ nanoparticles, see FIG. 11(e).

In Example 4, after 7 days of treatment with 1 microgram/liter of PEG-coated Fe₃O₄ 6.7 nm nanoparticles, the biofilm had a reduction in bio-volume of from about 0.8 μm³/μm² to about 0.6 μm³/μm². Meanwhile, when a higher concentration of nanoparticles was applied (100 μg/L), the biofilm bio-volume was reduced to about 0.5 μm³/μm². This is observed in a comparison of FIG. 11(d), which shows a biofilm 7 days after treatment with the 1 μg/L of 6.7 nm Fe₃O₄ nanoparticles, with FIG. 11(e), which shows a biofilm 7 days after treatment with 100 μg/L of 6.7 nm Fe₃O₄ nanoparticles, where the amount of dispersion is similar.

Further, after 7 days of treatment, both the biofilm treated with 1 μg/L of 6.7 nm Fe₃O₄ nanoparticles and the biofilm treated with 100 μg/L of 6.7 nm Fe₃O₄ nanoparticles showed an increase in roughness coefficient, indicating that the thickness of each of the treated biofilms was not uniform, which is indicative of biofilm dispersion and cell loss. The roughness coefficient for the untreated biofilm was about 1.25, while the roughness coefficient for the biofilm treated with 1 μg/L of 6.7 nm Fe₃O₄ nanoparticles was about 1.5 and the roughness coefficient for the biofilm treated with 100 μg/L of 6.7 nm Fe₃O₄ nanoparticles was also about 1.5.

### Example 5

In Example 5, polyethylene glycol (PEG) (having a molecular weight of 2000) thiol-coated gold nanoparticles having a particle size of 11 nm in diameter were formed by the following method. A 50 mL solution of 0.25 mM gold Ill chloride was prepared in DI water. To this solution, 0.90 ml of 0.01 M PEG2000-thiol was added. The mixture was stored for 10 minutes, then 0.06 mL of a 0.25 M sodium borohydride solution was added. The mixture was allowed to stir for 30 minutes and resulted in stable PEG-thiol-coated gold nanoparticles.

TEM of the gold nanoparticles demonstrated that the nanoparticles have an average diameter of 11.25 nm with a standard deviation of 7.47 nm. DLS reported a z-average size of 73.01 nm, and an intensity mean of 57.05 nm.

The gold nanoparticle stock solutions had a zeta potential of −8.95 mV, which shifted to −0.839 mV in MHW.

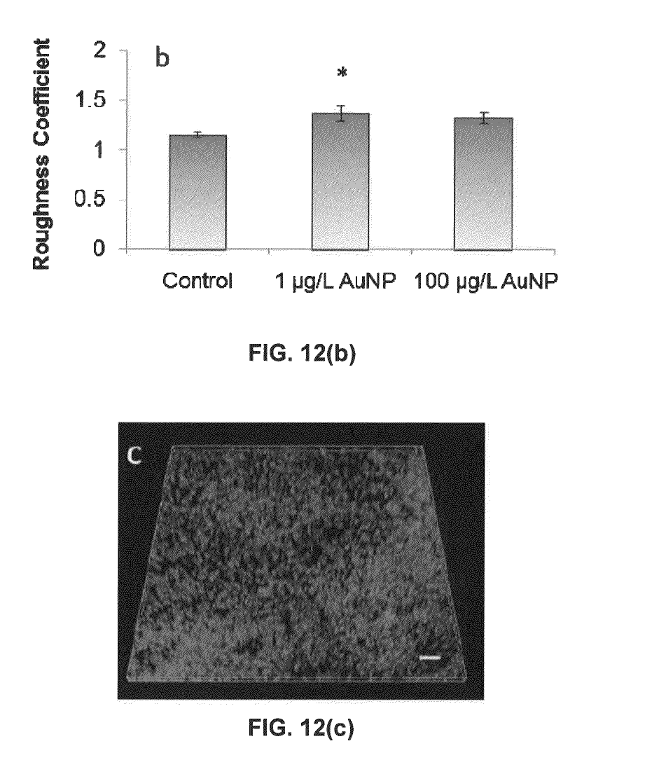

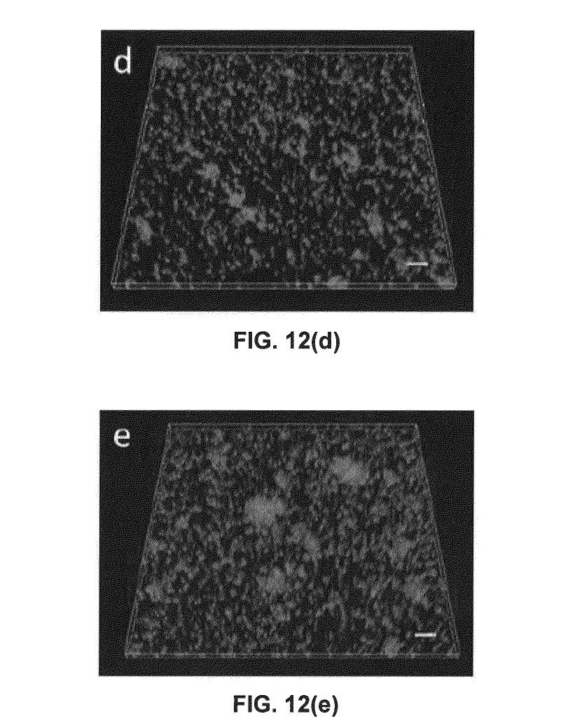

Testing results from Example 5 are shown in FIGS. 12(a) through 12(e). COMSTAT analysis of biofilms after exposure to 1 μg/L of 11 nm gold nanoparticles shows a slight decrease in biofilm bio-volume, see FIG. 12(a), although the decrease was not significantly different from the control bio-volume, as well as a significant increase in roughness coefficient, see FIG. 12(b). No statistically significant effects were observed at 100 μg/L. Fluorescent confocal images show a control biofilm, see FIG. 12(c), and biofilms after exposure to 1 μg/L 11 nm of gold nanoparticles, see FIG. 12(d), and 100 μg/L 11 nm of gold nanoparticles, see FIG. 12(e).

In Example 5, after 7 days of treatment with 1 microgram/liter of PEG-thiol coated 11 nm gold nanoparticles, the biofilm had a reduction in bio-volume of from about 1.0 μm³/μm² to about 0.7 μm³/μm². Meanwhile, when a higher concentration of nanoparticles was applied (100 μg/L), the biofilm bio-volume was reduced to about 0.8 μm³/μm². This is observed in a comparison of FIG. 12(d), which shows the biofilm 7 days after treatment with 1 μg/L of 11 nm gold nanoparticles, and 12(e), which shows the biofilm 7 days after treatment with 100 μg/L of 11 nm gold nanoparticles, where there is more dispersion in FIG. 12(d) as compared to 12(e).

Further, after 7 days of treatment, both the biofilm treated with 1 μg/L of gold nanoparticles and the biofilm treated with 100 μg/L of gold nanoparticles showed a slight increase in roughness coefficient, indicating the thickness of the biofilms was not uniform, which is indicative of biofilm dispersion and cell loss. The roughness coefficient for the untreated biofilm was about 1.1, while the roughness coefficient for the biofilm treated with 1 μg/L of gold nanoparticles was about 1.3 and the roughness coefficient for the biofilm treated with 100 μg/L of gold nanoparticles was about 1.2.

### Example 6

In example 6, the effects of nanoparticles on planktonic L. pneumophila were tested. Legionella pneumophila from a 3 day old BCYE plate was used to make a suspension in AYE having an optical density of 0.05 at 600 nanometers. Gold nanoparticles formed by the method of Example 5 were added to each flask at concentrations of 1, 100, and 1000 μg/L. Cultures were grown for 66 hours at 37° C. and 150 revolutions per minute (rpm), and samples were taken at 0, 18, 30, 48 and 66 hours. At each time point, 1 milliliter was removed from each sample and centrifuged at 8000 rpm for five minutes at room temperature. The supernatant was removed and read at an optical density of 400 nm to determine pigment production, which is related to the virulence of the bacteria. The pellet was then re-suspended in phosphate buffered saline (PBS) and biomass was determined by measuring the optical density at 600 nm. Cell viability (colony forming units/ml) was also determined by serial dilution plating.

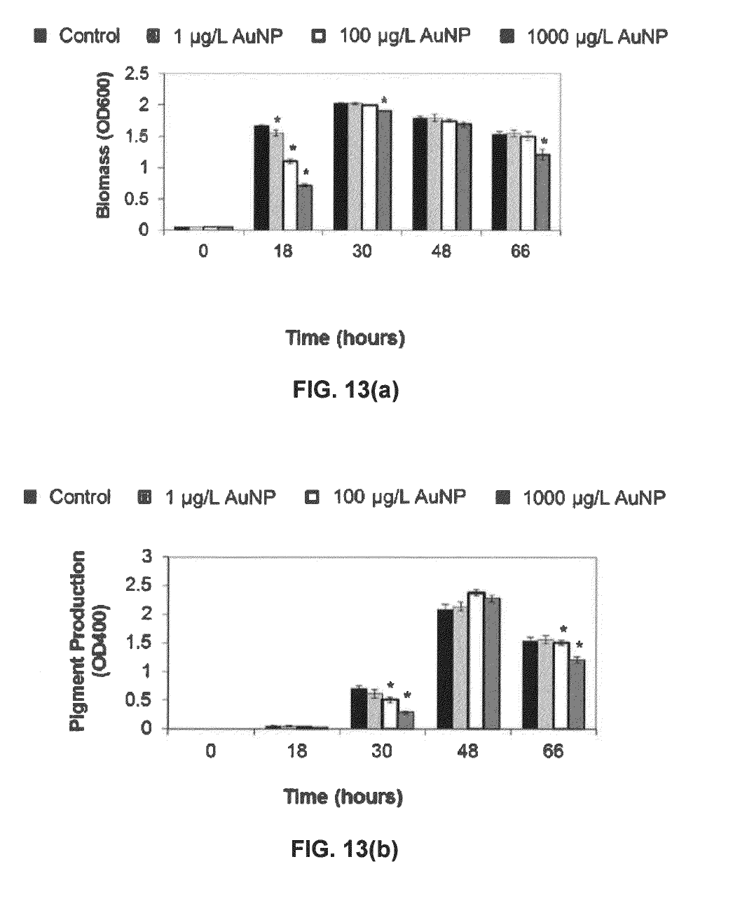

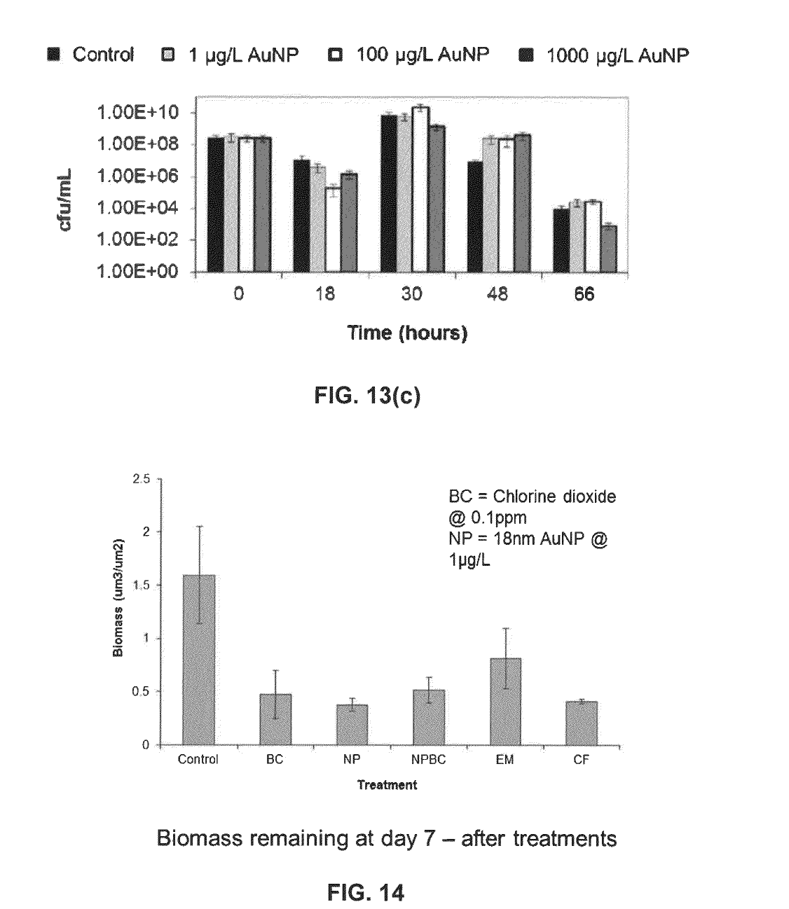

The effect of the interaction of PEG-coated gold nanoparticles with planktonic L. pneumophila is shown in FIGS. 13(a), 13(b), and 13(c). Cells were exposed to concentrations 1, 100, and 1000 μg/L 11 nm gold nanoparticles for 66 hours. Significant differences in biomass, and pigment production were seen at specific time points and concentrations as shown, but no significant difference in cell viability was observed. Specifically, Legionella exposed to 1, 100, and 1000 μg/L of PEG-coated gold nanoparticles showed significantly reduced biomass at an optical density of 600 nanometers after 18 hours of exposure, as shown in FIG. 13(a). Exposure to 1000 μg/L of the gold nanoparticles also resulted in a biofilm having a significantly lower biomass at 30 and 66 hours. Further, pigment production was significantly lower in the 100 and 1000 μg/L treatments at 30 and 66 hours, as shown in FIG. 13(b). Meanwhile, cell viability was similar between controls and treatments for each time point, as shown in FIG. 13(c).

### Example 7

In Example 7, a biofilm was treated with (1) 1 microgram/milliliter of PEG-coated nanoparticles formed by the method described in Example 5 but having a diameter of 18 nanometers, (2) 0.1 parts per million (ppm) (equivalent to 0.1 milligrams/L) of chlorine dioxide biocide, and (3) a combination of the nanoparticles and biocide. The biofilm was also treated with erythromycin (EM) and ciprofloxacin (CF). The treatments lasted for 7 days, and the biomass in micrometers³/micrometers² was compared to a control biofilm that received no treatment. The results are shown in FIG. 14. The control biofilm retained a biovolume of about 1.5 micrometers³/micrometers², while the nanoparticle-treated biofilm had a reduced biomass of about 0.4 micrometers³/micrometers², the biocide treated biofilm had a reduced biomass of about 0.5 micrometers³/micrometers², and the biofilm treated with the combination of the nanoparticles and the biocide had a reduced biomass of about 0.5 micrometers³/micrometers². As seen from FIG. 14, treatment of the biofilms with nanoparticles alone or in combination with a chlorine dioxide biocide reduces the biomass of the biofilm compared to a no treatment control.

### Example 8

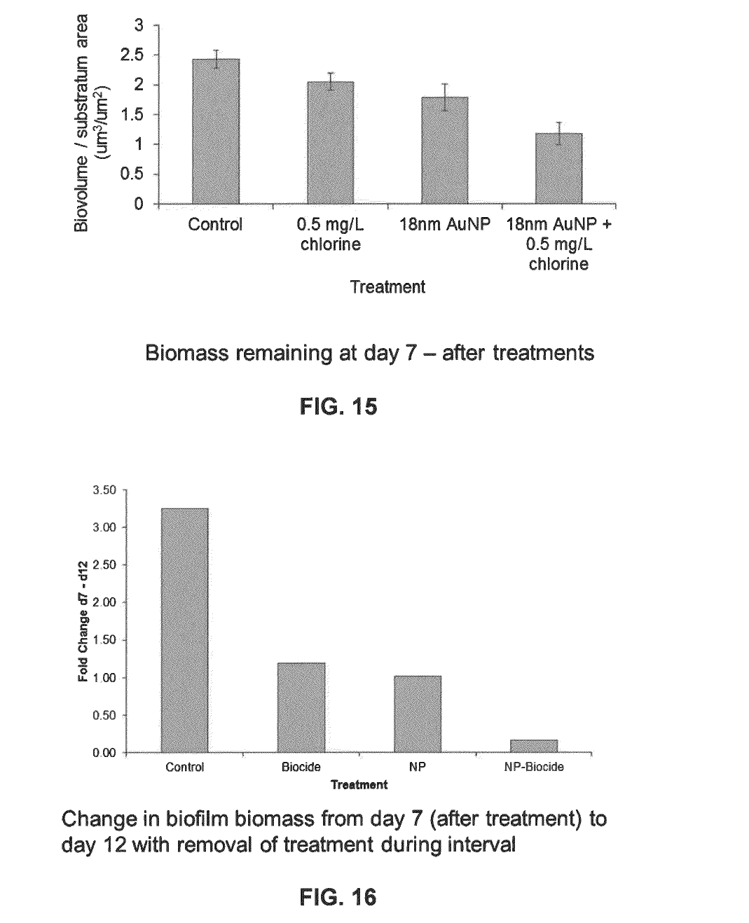

In example 8, a biofilm was treated with (1) 1 microgram/milliliter of PEG-coated nanoparticles formed by the method described in Example 4 but having a diameter of 18 nanometers, (2) 0.5 milligrams/liter of chlorine biocide, and (3) a combination of the nanoparticles and the biocide. The treatments lasted for 7 days, and the biomass in micrometers³/micrometers² was compared to a control biofilm that received no treatment. The results are shown in FIG. 15. The control biofilm retained a biomass of about 2.5 micrometers³/micrometers², while the nanoparticle-treated biofilm had a reduced biomass of about 1.9 micrometers³/micrometers², the biocide-treated biofilm had a reduced biomass of about 2.0 micrometers³/micrometers², and biofilm treated with the combination of the nanoparticles and the biocide had a reduced biomass of about 1.4 micrometers³/micrometers². As seen from FIG. 15, treatment of a biofilm with nanoparticles alone or in combination with a chlorine biocide reduces the biomass of the biofilm compared to no treatment, although the combination of the nanoparticles with the biocide demonstrated the greatest ability to reduce the biomass of the biofilm.

### Example 9

In Example 9, after the biofilms of Example 7 were treated for 7 days, the treatment was stopped, and on day 12 (5 days post-treatment), the fold change in the biofilm biomass for (1) the control biofilm, (2) the gold nanoparticle-treated biofilm, (3) the biocide-treated biofilm, and (4) the combination gold nanoparticle/biocide-treated biofilm was measured. As shown in FIG. 16, the control biofilm had a 3.25 fold increase in its biomass on day 12, while the biocide-only and nanoparticle-only treated biofilms had about a 1.25 fold increase and about a 1.0 fold increase in biomass, respectively. Meanwhile, the nanoparticle and biocide treated biofilm had only about a 0.2 fold increase in biomass, showing that treating a biofilm with both a biocide and metallic nanoparticles in combination can prevent regrowth of the biofilm after treatment has stopped.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A system of stabilized metal nanoparticles, the system comprising:
metallic nanoparticles;
a hydrophilic polymer; and
a nitrocatechol-based ligand; wherein the hydrophilic polymer is reacted with the nitrocatechol-based ligand to form a nitrocatechol-terminated hydrophilic polymer, further wherein the metallic nanoparticles are coated with the nitrocatechol-terminated hydrophilic polymer.

2. The system of claim 1, wherein the metallic nanoparticles are magnetic.

3. The system of claim 2, wherein the metallic nanoparticles comprise magnetite (Fe₃O₄).

4. The system of claim 1, wherein the metallic nanoparticles comprise platinum, silver, gold, or a combination thereof.

5. The system of claim 1, wherein the metallic nanoparticles have an average diameter ranging from about 1 nanometer to about 50 nanometers.

6. The system of claim 1, wherein the hydrophilic polymer comprises polyethylene glycol, polyethylene oxide, polyvinyl alcohol, polyacrylic acid, polymethacrylic acid, poly(maleic anhydride-alt-1-octadecane), polyethyleneimine, poly-N-vinyl-2-pyrollidone, cyclodextrin, or a combination thereof.

7. The system of claim 6, wherein the hydrophilic polymer comprises polyethylene glycol or polyethylene oxide.

8. The system of claim 1, wherein the nitrocatechol-based ligand comprises a tri-nitrated 3,4 dihydroxy-L-phenylanaline (tri-nitroDOPA).

9. The method of claim 8, wherein the tri-nitroDOPA has the following structure: 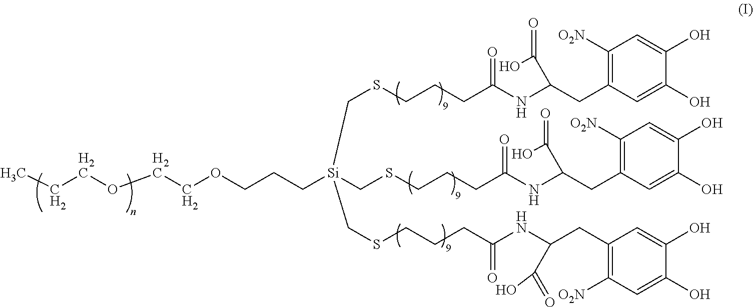
wherein n is an integer of 1 or greater.

10. A method for treating a surface to disrupt or disperse a biofilm present on the surface, the method comprising contacting a biofilm with a solution comprising from about 0.01 micrograms per liter to about 1000 micrograms per liter of stabilized metallic nanoparticles.

11. The method of claim 10, wherein the metallic nanoparticles comprise platinum, silver, iron, gold, or a combination thereof.

12. The method of claim 10, wherein the stabilized metallic nanoparticles are charge stabilized with negatively-charged citrate ions.

13. The method of claim 10, wherein the stabilized metallic nanoparticles are sterically stabilized with a hydrophilic polymer.

14. The method of claim 13, wherein the hydrophilic polymer comprises polyethylene glycol, polyethylene oxide, polyvinyl alcohol, polyacrylic acid, polymethacrylic acid, poly(maleic anhydride-alt-1-octadecane), polyethyleneimine, poly-N-vinyl-2-pyrollidone, cyclodextrin, or a combination thereof.

15. The method of claim 13, wherein the hydrophilic polymer is reacted with a nitrocatechol-based ligand to form a nitrocatechol-terminated hydrophilic polymer.

16. The method of claim 15, wherein the nitrocatechol-based ligand comprises a tri-nitrated 3,4 dihydroxy-L-phenylanaline (tri-nitroDOPA).

17. The method of claim 16, wherein the tri-nitroDOPA has the following structure: 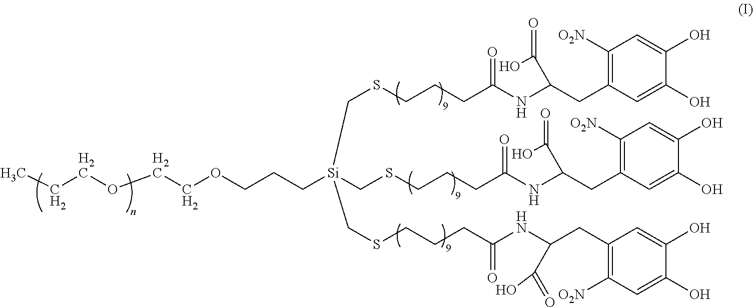
wherein n is an integer of 1 or greater.

18. The method of claim 10, wherein the solution further comprises a biocide.

19. The method of claim 18, wherein the solution comprises from about 0.01 milligrams per liter to about 1 gram per liter of the solution.

20. A biofilm treatment solution, the solution comprising from about 0.01 micrograms per liter to about 1000 micrograms per liter of stabilized metallic nanoparticles, wherein the nanoparticles have been stabilized with citrate ions or a hydrophilic polymer.
